(19) United States
(12) Patent Application Publication
(10) Pub. No.: US 2018/0015398 A1
(43) Pub. Date: Jan. 18, 2018

(54) Priming Stations and Methods of Priming a Fluidic Cartridge

(71) Applicant: Canon U.S. Life Sciences, Inc., Rockville, MD (US)

(72) Inventors: Joshua Mull, Baltimore, MD (US); Owen Lu, Baltimore, MD (US); Eric Schneider, Catonsville, MD (US); Collin Grimes, Columbia, MD (US); Jamie Kendall, Frederick, MD (US); Franklin Francis Regan, IV, Baltimore, MD (US); Ralph McCann, Newport News, VA (US); Scott Sundberg, Newport News, VA (US); Makoto Ogusu, Newport News, VA (US); Sean Ison, Newport News, VA (US); Jared Spaniol, Newport News, VA (US); Shulin Zeng, Silver Spring, MD (US); Ivor Knight, Arlington, VA (US)

(73) Assignee: Canon U.S. Life Sciences, Inc., Rockville, MD (US)

(21) Appl. No.: 15/644,986

(22) Filed: Jul. 10, 2017

Related U.S. Application Data
(60) Provisional application No. 62/361,158, filed on Jul. 12, 2016.

(51) Int. Cl. B01D 35/147; B01D 35/153; B01D 35/30

(52) U.S. Cl. CPC B01D 35/147; B01D 35/30; B01D 35/153; B01L 2200/06; B01L 2200/10; B01D 2201/302

(57) ABSTRACT

The present invention relates to systems and methods for preparing a fluidic cartridge for use in an analyzer device. In one non-limiting aspect, the present invention provides a method of preparing a fluidic cartridge for use in an analyzer device. The method may include controlling valves and a vacuum pump of a priming station to evacuate air from a fluidic cartridge loaded in the priming station. The method may include controlling the valves and the vacuum pump to draw priming fluid into sipper wells and channels of the loaded fluidic cartridge. In another non-limiting aspect, the present invention provides a priming station for preparing a fluidic cartridge for use in an analyzer device. The priming station may include a vacuum pump, a priming manifold assembly, and a controller. The priming manifold assembly may be configured to interface with a fluidic cartridge loaded in the priming station.

### CROSS-REFERENCES TO RELATED APPLICATIONS

This application claims the benefit of U.S. Provisional Patent Application Ser. No. 62/361,158, filed on Jul. 12, 2016, which is incorporated herein by reference in its entirety.

### BACKGROUND

### Field of Invention

The present invention relates to preparing fluidic cartridges for use in an analyzer device. More specifically, the present invention relates to systems and methods for priming a fluidic cartridge by filling the fluidic cartridge with a fluid.

### Discussion of the Background

An analyzer device (e.g., a genetic analyzer device) may have limited vacuum capabilities. Accordingly, to reduce fluid path resistances in a fluidic cartridge used in an analyzer device, the fluidic cartridge may be primed (i.e., pre-filled with fluid) before use in the analyzer device. However, the priming process is a time-consuming (e.g., 1.5 hours), labor-intensive, manual process.

For example, one conventional priming process may require a user to take actions including: (1) preparing and degassing priming fluid, (2) preparing a cartridge for priming, (3) installing the cartridge in a second water tank, and (4) priming the cartridge. Preparing and degassing the priming fluid may include (i) filling a first tank with water, (ii) manually opening a first valve and turning on a vacuum pump to degas the water in the first tank, (iii) reading a first pressure gauge to verify that the pressure generated by the vacuum pump is sufficient to degas the water, and (iv) allowing the water to degas for at least 30 minutes.

Preparing the cartridge for priming may include (i) applying first and second layers of electrical tape over the waste wells of the cartridge, (ii) applying first and second layers of electrical tape over the vent wells of the cartridge, (iii) applying a long piece of electrical tape perpendicular to the electrical tape on the waste wells that will allow the cartridge to be taped to the side walls of a second tank, and (iv) using a blade or pin-like device to pierce holes in the electrical tape over the blanking fluid wells.

Installing the cartridge in a second water tank may include (i) placing the cartridge in an upright position (i.e., with the waste wells closest to the top of the second tank and with the sipper and vent wells closest to the bottom of the second tank), (ii) slowly bring the second tank to vacuum over a 5 minute period by slowly opening a regulator in a counterclockwise direction, (iii) monitoring the electrical tape for any bubbles over the wells, and (iv) limiting the rate of pressure change to avoid bubbles bridging to the edge of the electrical tape.

Priming the cartridge may include (i) manually closing the first valve, cracking open a second valve to raise the pressure in the first tank, and then closing the second valve, (ii) opening a third valve slowly enough to avoid spraying water into the second tank, (iii) letting water fill the second tank until the water is just up to the top of the sipper wells and then immediately closing the third valve (allowing the water to go higher may cause damage to the cartridge), (iv) waiting 15 minutes or more, (v) closing a regulator on the second tank by turning it clockwise all the way, (vi) turning off the vacuum pump, (vii) opening a fourth valve slowly over a 5 minute period until a second pressure gauge indicates a pressure of 0 in-Hg, (viii) waiting 15 minutes, (ix) carefully removing the cartridge from the second tank while ensuring the electrical connections stay dry, (x) drying off water from the outside of the cartridge except for the sipper wells, which should have water in them, (xi) inspecting the channels of the cartridge to see if they are primed, (xii) verify that all of the vent and waste wells are half filled or more with water, and (xiii) adding water to the sipper wells to keep the ends of the sippers submerged.

Accordingly, what is desired is an improved system and method for priming a fluidic cartridge.

### SUMMARY

The present invention relates to systems and methods for preparing a fluidic cartridge for use in an analyzer device. In the following description, the present invention is described with reference to embodiments that may make use of one or more of sipper wells, vent wells, and waste wells. However, the present invention is not so limited and instead is applicable to priming any cartridge having multiple sets of wells (e.g., any cartridge having at least two wells for application of pressures and one well for adding a fluid/gas to the cartridge.

In one aspect, the present invention provides a method of preparing a fluidic cartridge for use in an analyzer device. The method may include controlling valves and a vacuum pump of a priming station to evacuate air from a fluidic cartridge loaded in the priming station. The method may include controlling the valves and the vacuum pump to draw priming fluid into sipper wells and channels of the loaded fluidic cartridge.

In another aspect, the present invention provides a priming station for preparing a fluidic cartridge for use in an analyzer device. The priming station may include a vacuum pump, a priming manifold assembly, and a controller. The priming manifold assembly may be configured to interface with a fluidic cartridge loaded in the priming station. The priming manifold assembly may include valves, a vent-sipper manifold, and a vent-sipper gasket. The vent-sipper manifold may include a sipper fluid reservoir and a fluid fill channel. The sipper fluid reservoir may be configured to store priming fluid. The fluid fill channel may be configured to allow priming fluid to enter the sipper fluid reservoir. The vent vent-sipper manifold may be configured to connect a vacuum line from the vacuum pump to the sipper fluid reservoir via one of the valves and to connect a vacuum line from the vacuum pump to vent wells of the loaded fluidic cartridge via one or more of the valves. The vent-sipper gasket may be configured to create a seal between the vent-sipper manifold and a surface of the loaded fluidic cartridge and to create a common sipper volume with the sipper fluid reservoir. The priming fluid may be capable of being drawn from the common sipper volume into sipper wells of the loaded fluidic cartridge. The controller may be configured to control the vacuum pump and the valves to draw priming fluid from the common sipper volume into sipper wells and channels of the loaded fluidic cartridge.

In some embodiments, the priming fluid may be water, oil, or another non-aqueous fluid. In some embodiments, the water may be deionized water.

The above and other embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements. Additionally, the left-most digit(s) of the reference number identifies the drawing in which the reference number first appears.

FIG. 1 is an exploded view of a priming station embodying aspects of the present invention.

FIG. 2 illustrates an example of a fluidic cartridge according to one non-limiting embodiment.

FIG. 3 is an exploded view of a priming manifold assembly according to one non-limiting embodiment.

FIG. 4 is an exploded view of a top assembly according to one non-limiting embodiment.

FIG. 5 illustrates a bottom view of a vent-sipper gasket and its alignment with a cartridge according to one non-limiting embodiment.

FIG. 6 illustrates a bottom view of a waste well gasket and its alignment with a cartridge according to one non-limiting embodiment.

FIG. 7 shows a bottom surface of the vent-sipper manifold according to one non-limiting embodiment.

FIG. 8 illustrates a cross section of the vent-sipper manifold according to one non-limiting embodiment.

FIG. 9 illustrates the top of the vent-sipper manifold according to one non-limiting embodiment.

FIG. 10 illustrates a side view of the vent-sipper manifold according to one non-limiting embodiment.

FIG. 11 illustrates a valve mounting location on a side of the vent-sipper manifold according to one non-limiting embodiment.

FIG. 12 is a perspective view of a fluid fill tubing assembly 418 according to one non-limiting embodiment.

FIGS. 13 and 14 illustrate a perspective view and a see-through view, respectively, of a waste manifold according to one non-limiting embodiment.

FIG. 15 illustrates a bottom view of a manifold frame according to one non-limiting embodiment.

FIG. 16 illustrates a top view of the vent-sipper and waste manifolds and according to one non-limiting embodiment.

FIG. 17 illustrates a bottom view of the manifold frame according to one non-limiting embodiment.

FIG. 18 illustrates a cross-sectional view of the manifold frame, a manifold gasket, and a chip base plate according to one non-limiting embodiment.

FIG. 19 illustrates a bottom view of the manifold gasket on the manifold frame according to one embodiment.

FIG. 20 illustrates a bottom view of the vent-sip manifold gasket and the waste manifold gasket on the manifold frame according to one embodiment.

FIG. 21A illustrates a bottom view of the manifold frame according to one non-limiting embodiment, and FIG. 21B illustrates a top view of the vent-sipper and waste manifolds according to one non-limiting embodiment.

FIG. 22 illustrates a perspective view of sleeve bearings according to one non-limiting embodiment.

FIG. 23 illustrates a perspective view of the chip base plate according to one non-limiting embodiment.

FIG. 24 is a perspective view of a limit switch extension according to one non-limiting embodiment.

FIG. 25 is a cross-sectional view of the limit switch extension, manifold frame, and chip base plate according to one non-limiting embodiment.

FIG. 26 is a perspective view of an assembled priming manifold assembly according to one non-limiting embodiment.

FIG. 27 is a cross-sectional view of a hinge of the priming station according to one non-limiting embodiment.

FIG. 28 illustrates a perspective view of a portion of a priming station base plate according to one non-limiting embodiment.

FIG. 29 illustrates a perspective view of the priming station base plate according to one non-limiting embodiment.

FIG. 30 illustrates a perspective view of an enclosure cover according to one non-limiting embodiment.

FIG. 31 illustrates a perspective view of a manifold cover according to one non-limiting embodiment.

FIG. 32 illustrates a perspective view of a plug according to one non-limiting embodiment.

FIG. 33 illustrates a perspective view of the plug and a grommet according to one non-limiting embodiment.

FIG. 34A is a cross-sectional view of the priming manifold assembly according to one non-limiting embodiment.

FIGS. 34B and 34C are enlarged cross-sectional views of a compressed waste manifold gasket and a compressed manifold gasket, respectively, according to some non-limiting embodiments.

FIG. 35 is a functional block diagram illustrating a PCB and components of the priming station 100 with which the PCB interacts according to one non-limiting embodiment.

FIG. 36 is a flowchart illustrating a process for priming a cartridge according to some non-limiting embodiments.

FIG. 37 is a flowchart illustrating a cartridge loading process according to one non-limiting embodiment.

FIG. 38 is a flowchart illustrating a fluid degassing process according to one non-limiting embodiment.

FIG. 39 is a flowchart illustrating an alternative fluid degassing process according to one non-limiting alternative embodiment, and FIG. 40 is a flowchart illustrating the alternative fluid degassing process in more detail.

FIG. 41 is a flowchart illustrating a cartridge evacuation process according to one non-limiting embodiment.

FIG. 42 is a flowchart illustrating a cartridge priming process according to one non-limiting embodiment.

FIG. 43 is a flowchart illustrating a cartridge removal process according to one non-limiting embodiment.

FIG. 44 is a flowchart illustrating a vacuum pump blowout process according to one non-limiting embodiment.

FIG. 45A illustrates a pressure profile of the priming process according to one non-limiting embodiment, and FIG. 45B shows a magnified portion of the pressure profile, which is identified by the dashed rectangle of FIG. 45A.

FIG. 46A shows a pressure profile of the priming process according to a non-limiting alternative embodiment, and FIG. 46B shows a magnified portion of the alternative pressure profile, which is identified by the dashed rectangle in FIG. 46A.

FIG. 47 illustrates a pressure profile of a priming process according to a non-limiting embodiment that includes two blowout steps.

FIG. 48 illustrates a pressure profile of a priming process according to a non-limiting alternative embodiment in which a blowout routine is not performed until after the cartridge is removed from the priming station.

FIG. 49 illustrates a pressure profile of the priming process according to a non-limiting embodiment.

### DETAILED DESCRIPTION OF PREFERRED EMBODIMENTS

Priming Station Overview

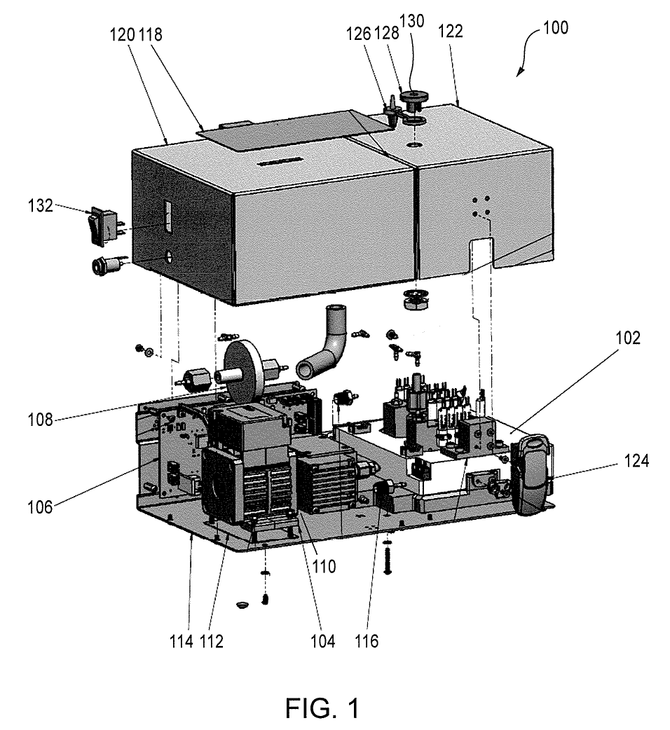

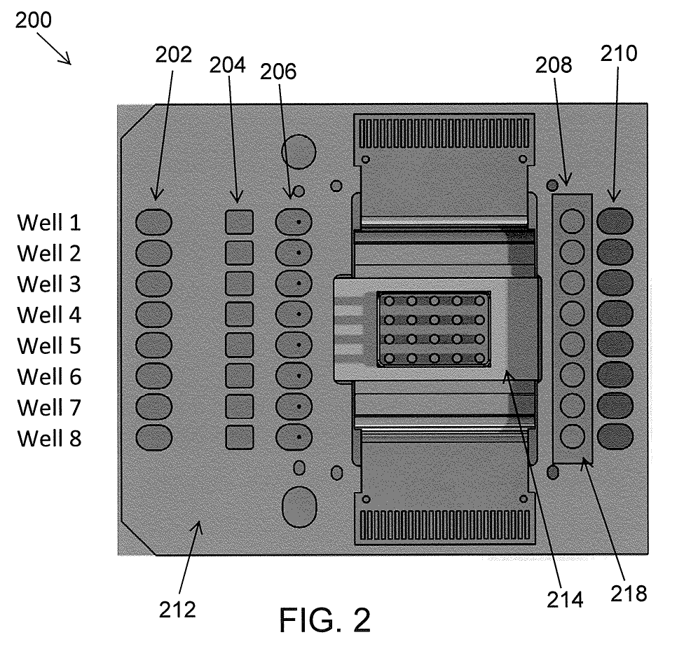

FIG. 1 is an exploded view of a priming station 100 embodying aspects of the present invention. The priming station 100 may be designed to prepare fluidic cartridges (e.g., the fluidic cartridge 200 illustrated in FIG. 2) for use in an analyzer device (e.g., a genetic analyzer device). The cartridges may contain one or more channels (e.g., micro channels) with one or more hydrophilic to hydrophobic connections that may create large resistances to fluid flow. The analyzer device may have limited vacuum capabilities, and the cartridges may be pre-filled with a priming fluid, such as, for example and without limitation, de-ionized (“DI”) water, before use in the analyzer device to reduce the cartridge fluid path resistances. In some embodiments, the priming station 100 may accomplish this task using valves 422 (e.g., solenoid valves) and a deep vacuum pump 110. In some embodiments, the priming station 100 may degass the priming fluid before creating pressure differentials to push the priming fluid through the cartridge channels.

Cartridge Overview

The priming station 100 may be designed to interface with a fluidic cartridge 200, which may be, for example and without limitation, a consumable fluidic cartridge. FIG. 2 illustrates an example of a fluidic cartridge 200 according to one non-limiting embodiment. In the illustrated embodiment, the cartridge 200 contains 5 banks of wells, which are labelled as 202, 204, 206, 208, and 210, respectively, and each bank contains 8 wells. However, this is not required, and, in alternative embodiments, the cartridge 200 may have a different number of banks and/or a different number of wells. In some embodiments, banks 202 and 210 may be for storage only and may not connect to fluid channels of the cartridge 200. Therefore, the storage wells of banks 202 and 210 may require no action when priming the cartridge 200, and the priming station 100 may not interface with these storage wells. Bank 204 may contain vent wells, bank 206 may contain sipper wells, and bank 208 may contain waste wells.

In some embodiments, the cartridge 200 may include an interface chip (i.e., K-chip) 212 and a reaction chip (i.e., U-chip) 214. In some embodiments, the sipper, vent, and waste wells may be connected via channels in the K-chip and U-chip of the cartridge 200. The fluid channel leaving each sipper well in bank 206 may branch into two channels, with one channel going to a respective vent well of bank 204 and one channel traveling to a respective waste well of bank 208. These are the channels that may need to be filled with fluid before the cartridge is inserted into an analyzer device.

In some embodiments, the cartridge 200 may include a removable docking feature over the sipper wells for alignment with the analyzer device and/or an amplicon membrane 218 over the waste wells to avoid contamination in the analyzer device. In some embodiments, the docking feature may be removed before insertion of the cartridge 200 into the priming station 100 to allow simple sealing with the sipper wells. However, in some embodiments, the membrane 218 may not be removable.

Priming Station Architechture

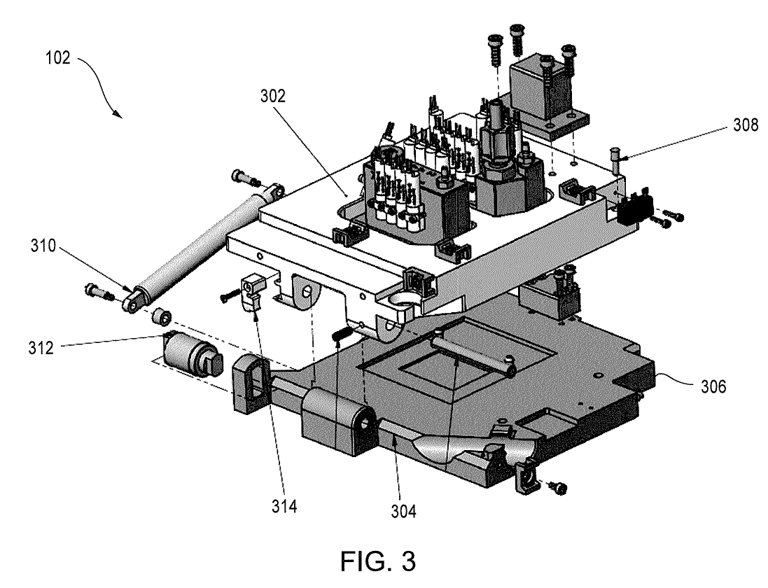

As illustrated in FIG. 1, the priming station 100 may include a priming manifold assembly 102. FIG. 3 is an exploded view of the priming manifold assembly 102 according to one non-limiting embodiment. As illustrated in FIG. 3, the priming manifold assembly 102 may include a top assembly 302 and a chip base bearing assembly 304.

Top Assembly

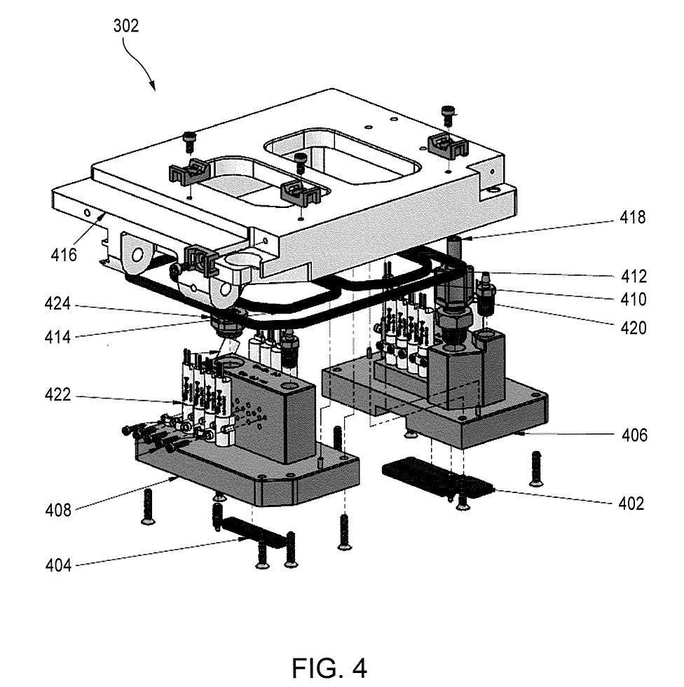

FIG. 4 is an exploded view of the top assembly 302 according to one non-limiting embodiment. In some embodiments, a purpose of the top assembly 302 may be to interface with the cartridge 200. The top assembly 302 may contain one or more of channels, gaskets, valves 422, and fittings configured to insert fluid and apply a vacuum over the cartridge 200. The top assembly 302 may also provide the support structure for clamping down the cartridge interface to create a good seal.

As illustrated in FIG. 4, the top assembly 302 may include one or more of a vent-sipper gasket 402, a waste well gasket 404, a vent-sipper manifold 406, a waste manifold 408, a manifold gasket 410, a vent-sipper manifold gasket 412, a waste manifold gasket 414, a manifold frame 416, a fluid fill tubing assembly 418, a vacuum line fitting 420, valves 422, and an air filter 424. Individual components of the top assembly 302 are described below.

Vent-Sipper Gasket

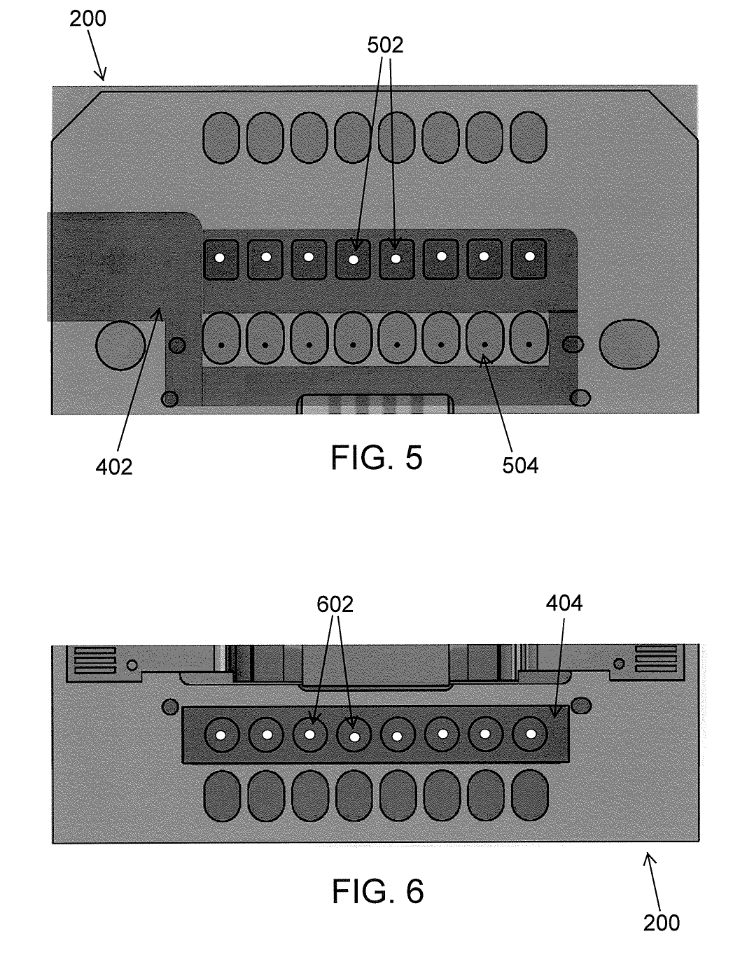

In some embodiments, the vent-sipper gasket 402 may create a seal between the surface of the cartridge 200 and the vent-sipper manifold 406, to which vent-sipper gasket 402 may be adhered. FIG. 5 illustrates a bottom view of the vent-sipper gasket 402 and its alignment with the cartridge 200 according to one non-limiting embodiment. In FIG. 5, the bottom of the vent-sipper gasket 402 is seen through the cartridge 200, which is illustrated as transparent.

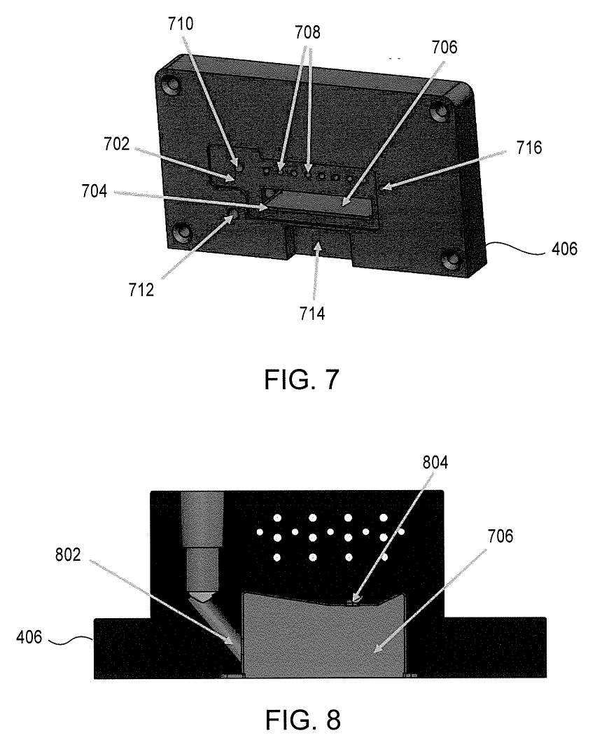

In some embodiments, the vent-sipper gasket 402 may include vent well ports 502 that isolate each vent well of the cartridge 200 and connect each vent well to a corresponding vent channel 708 in the vent-sipper manifold 406 (see FIG. 7). The vent-sipper gasket 402 may also seal around all of the sipper wells to create a sipper common volume 504 with a common sipper fluid reservoir 706 of the vent-sipper manifold 406. The vent-sipper gasket 402 may have a cartridge check port, which seals around a cavity on the cartridge 200 to perform a cartridge presence check.

Waste Well Gasket

In some embodiments, the waste well gasket 404 may create a seal between the surface of the cartridge 200 and the waste manifold 408, to which the waste well gasket 404 may be adhered. FIG. 6 illustrates a bottom view of the waste well gasket 404 and its alignment with the cartridge 200 according to one non-limiting embodiment. In FIG. 6, the bottom of the waste well gasket 404 is seen through the cartridge 200, which is illustrated as transparent.

In some embodiments, the waste well gasket 404 may include waste well ports 602 that isolate each waste well of the cartridge 200 and connect each waste well to a corresponding channel in the waste manifold 408.

Vent-Sipper Manifold

In some embodiments, the vent-sipper manifold 406 may be the support structure that enables a proper vacuum and fluid placement over the vent and sipper wells of the cartridge 200. FIG. 7 shows the bottom surface of the vent-sipper manifold 406 according to one non-limiting embodiment.

In some non-limiting embodiments, the vent-sipper manifold 406 may include a recession 702 (e.g., a 0.04 in recession) to support the vent-sipper gasket 402. The recession may keep the adhesive plane of the vent-sipper gasket 402 from compressing outwards, which may cause unwanted transverse stresses on the adhesive. Thus, the recession 702 may mitigate gasket delamination issues. In some embodiments, the vent-sipper manifold 406 may additionally include a boss 704 in the recession 702 to support the thin, lower portion of the vent-sipper gasket 402, which may prevent the lower portion of the vent-sipper gasket 402 from being compressed into a common sipper fluid reservoir 706 in the vent-sipper manifold 406.

In some non-limiting embodiments, the vent-sipper manifold 406 may include vent channels 708 and a cartridge detect channel 710, and the vertical leg of each vent channel 708 and the cartridge detect channel 710 may be included on the bottom face of the vent-sipper manifold 406 along with the sipper fluid reservoir 706. These features may correspond to the vent well ports 502, cartridge check port, and sipper common volume 504 in the vent-sipper gasket 402, respectively.

FIG. 8 illustrates a cross section of the vent-sipper manifold 406 according to one non-limiting embodiment. As shown in FIG. 8, the sipper fluid reservoir 706 may include two connecting channels 802 and 804. In particular, the sipper fluid reservoir 706 may include fluid fill channel 802 and a vacuum channel 804. In some non-limiting embodiments, as shown in FIG. 8, the fluid fill channel 802 may be large (relative to the vacuum channel 804), may be on the side wall of the sipper fluid reservoir 706, and may connect to a fluid fill port 130 (e.g., on top of the priming station 100) to allow priming fluid insertion. The vacuum channel 804 may be relatively small, may be in the ceiling of the sipper fluid reservoir 706, and may connect to a vacuum line via a valve. In some non-limiting embodiments, the vacuum channel 804 may be on a raised surface and may be surrounded by a lip, which may reduce the amount of fluid pulled into the vacuum line from the sipper fluid reservoir 706.

In some embodiments, as shown in FIG. 7, the bottom surface of the vent-sipper manifold 406 may include a threaded hole 712 for an eject pin plunger and a cut-out 714, which may provide clearance for a heat sink on the cartridge 200.

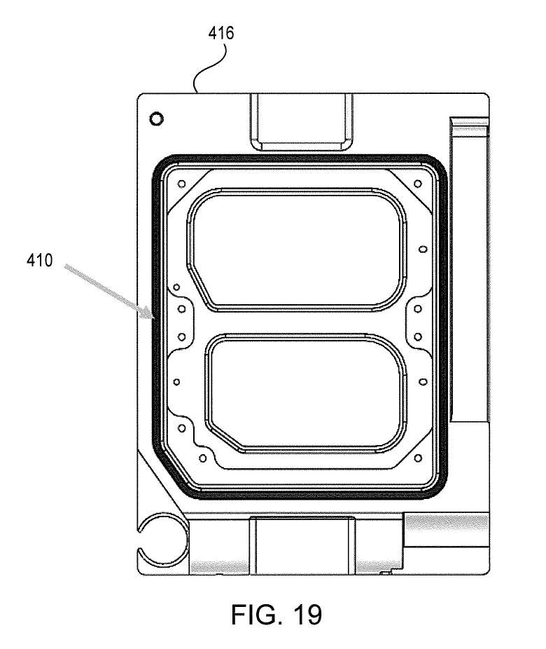

In some embodiments, as shown in FIG. 7, the bottom surface of the vent-sipper manifold 406 may include a channel 716 to equalize the vacuum in the sipper fluid reservoir 706 with the vacuum surrounding the outside of the in the U-chip 214 of the cartridge 200. In some non-limiting embodiments, the U-chip equalizer channel 716 may simply intersect the vacuum channel 804 that connects the sipper fluid reservoir 706 to the vacuum line, so any vacuum pulled on the sipper wells of the cartridge 200 will also be pulled in the area sealed by a manifold gasket 410 (see FIGS. 4 and 19), which includes the U-chip 214. The U-chip equalizer channel 716 may avoid stresses due to pressure differentials on the fragile U-chip 214. However, the U-chip equalizer channel 716 is not required, and, in some alternative embodiments, the vent-sipper manifold 406 may not include the U-chip equalizer channel 716.

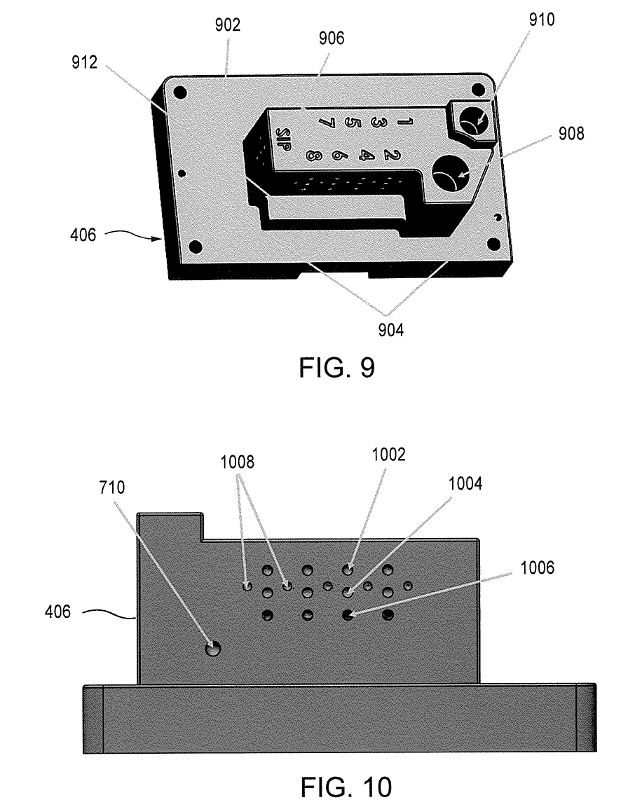

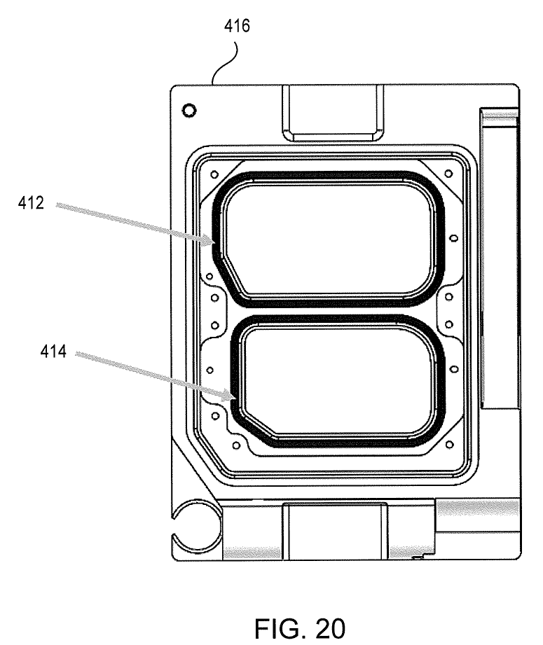

FIG. 9 illustrates the top of the vent-sipper manifold 406 according to one non-limiting embodiment. As shown in FIG. 9, the vent-sipper manifold 406 may include a surface 902 that may be the base of the vent-sipper manifold 406 and may be the sealing surface for a vent-sipper manifold gasket 412 (see FIGS. 4 and 20). The base of the vent-sipper manifold 406 may be designed to be sufficiently thick to support the compression of gaskets (e.g., gaskets 410, 412, and 414 of FIGS. 4, 19, and 20) on the cartridge 200 and between the vent-sipper manifold 406 and the manifold frame 416. The vent-sipper manifold 406 may include one or more (e.g., two) dowel pin holes 904 in the gasket sealing surface 902, which may align the vent-sipper manifold 406 with the manifold frame 416.

In some embodiments, as shown in FIG. 9, the vent-sipper manifold 406 may include a valve mounting boss 906 extending out of the base/gasket sealing surface 902. The valve mounting boss 906 may provide the mounting surfaces for all of the valves 422, a fluid fill tubing assembly 418, and a vacuum line fitting 420. In some non-limiting embodiments, the vacuum line fitting 420 may be a National Pipe Thread Taper (NPT) fitting. However, this is not required, and other fitting types may be used. The vent-sipper manifold 406 may include a fluid fill hole 908 (e.g., ⅛th NPT threaded hole) that connects the fluid fill tubing assembly 418 to the fluid fill channel 802 shown in FIG. 8. The vent-sipper manifold 406 may include a vacuum line hole 910 (e.g., a 1/16th NPT threaded hole) that connects the common vacuum line to the vacuum tubing via a barbed fitting 420.

In some embodiments, due to the variable nature of threads (e.g., NPT threads), one or more of holes 908 and 910 may be machined using the corresponding fittings as a reference. The holes 908 and 910 may be machined to a depth such that the fittings will create a good seal when tightened to a hard stop against the surface of the vent-sipper manifold 406. The vacuum line hole 910 may include a boss to raise the height of the assembled fitting above the height of the vacuum channel 804 entering the bottom of the threaded hole. In some embodiments, if the fitting tightens down further, it may block flow through the vacuum channel 804.

In some non-limiting embodiments, as shown in FIG. 9, the top surface of the valve mounting boss 906 may include labels to identify which well(s) on the cartridge 200 with which each valve is associated. In some embodiments, the vent-sipper manifold 406 may include a fluid reservoir boss 912, which may allow sufficient material around the cut-out for the sipper fluid reservoir 706, which may extend up past the surface of the manifold base/gasket sealing surface 902.

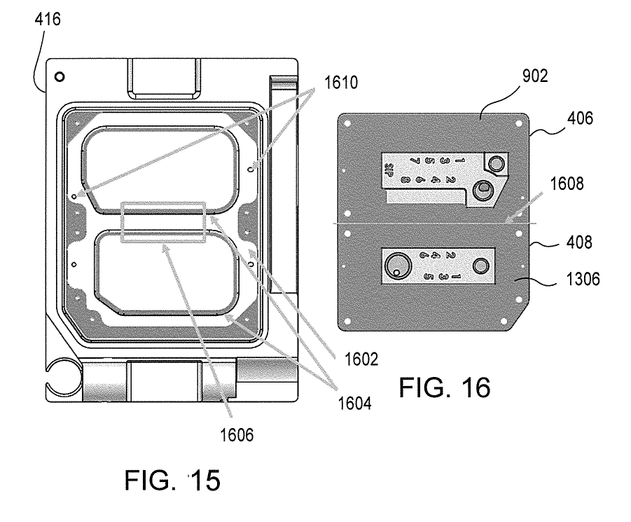

In some embodiments, the sides of the valve mounting boss 906 may include locations to attach valves to the vent-sipper manifold 406. In some non-limiting embodiments, each vent well in the cartridge 200 may port to a valve 422 (see FIGS. 4 and 15) through the vent-sipper manifold 406, which may be as indicated by labeling on the top surface of the valve mounting boss 906. The common sipper fluid reservoir 706 may port to the single valve location on the end of the valve mounting boss 906 of the vent-sipper manifold 406 labeled “SIP” (see FIG. 9).

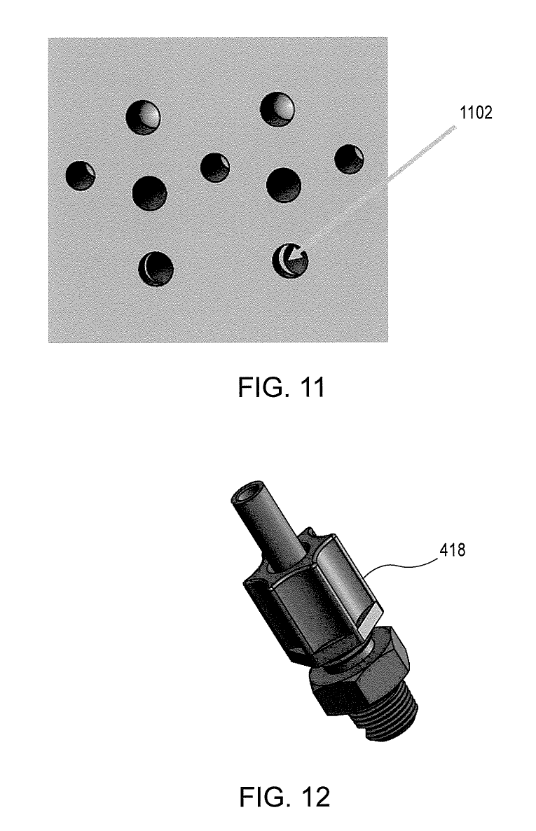

FIG. 10 illustrates a side view of the vent-sipper manifold 406 according to one non-limiting embodiment. In some non-limiting embodiments, as shown in FIG. 10, each valve mounting location may include 2 or 3 channels (e.g., depending on the number of valve ports). In some embodiments, the top channel 1002 in each mounting location may simply be a dead end in the vent-sipper manifold 406, the middle channel 1004 in each location may port to the common vacuum line (which may connect to the vacuum tubing via the 1/16th NPT fitting), and the bottom channel 1006 in each location may port to a unique vent valve 708 or the common sipper fluid reservoir 706. The top channel 1002 may correspond to a normally open port on the valves 422, the middle channel 1004 may correspond to a common port, and the bottom channel 1006 may correspond to a normally closed port. In some embodiments, because one or more of the bottom channels 1006 may not be perpendicular to the mounting plane (and could cause interference with the corresponding valve port), one or more of the channels 1006 may include a short perpendicular relief 1102 on the surface as shown in FIG. 11. With this port configuration, each 3-way valve 422 may act as a 2-way valve connecting or disconnecting the wells on the cartridge 200 to the vacuum line. In some embodiments, the valve mounting locations may include mounting holes 1008. In some embodiments, valve ports may mate with the holes for the top, middle, and bottom channels 1002, 1004, and 1006, which may be in vertical alignment. In some embodiments, valve mounting screws may attach to the mounting holes 1008.

In some embodiments, the vent channels 708 connecting to the vent ports may be similar in length in order to keep the vacuum “potential” the same for each well. If different channels had significantly different volumes, then the larger volume channels would be able to pull more fluid into a well than the smaller channels. Each well may be connected to a unique valve 422 for similar reasoning. Because the resistance of cartridge channels varies, some channels are easier to prime than others. Thus, if each well were connected to a common vacuum source, the vacuum “potential” would be more readily used by the lower resistance channels. Under these conditions, some wells may not prime or some wells may over prime. By pulling a common vacuum, then isolating each well by closing the corresponding valves, the priming level in each well remains consistent. However, a unique valve 422 for each vent well and each waste well is not required (e.g., because channel resistances may be sufficiently consistent, and proper priming may be achieved without using unique valves 422). Accordingly, in some alternative embodiments, the unique vent valves and the unique waste valves could be replaced by a single valve for each bank. Furthermore, the cartridge 200 could still be primed if the vent and waste valves were removed and the channels were simply sealed off (equivalent to placing tape over the vent and waste wells in chamber priming); however, similar to chamber priming, the control of fluid movement over the cartridge may be limited due to the inability to directly control pressure differentials without the valves (i.e., without any valves over the vent and waste wells, a deep vacuum may be pulled in the waste and vent wells via the sipper wells during degassing, then the vacuum may be released over the sipper wells, and the waste and vent wells may overfill because the vacuum levels cannot be adjusted or released after a certain time).

In some embodiments, as shown in FIG. 10, the forward face of the valve mounting boss 906 may include the final leg of the cartridge detect channel 710. This leg may open to the atmosphere to allow air to be pulled into the system if no loaded cartridge 200 is blocking the channel. In some non-limiting embodiments, the diameter of the cartridge detect channel 710 may be slightly larger than the other channels in the vent-sipper manifold 406 to decrease the air flow resistance when a cartridge 200 is not installed. If the resistance is too high, the pump 110 may still be able to pull a vacuum at the pressure sensor signaling the presence of a cartridge 200 when one is not there.

Fluid Fill Tubing Assembly

FIG. 12 is a perspective view of a fluid fill tubing assembly 418 according to one non-limiting embodiment. In some embodiments, as shown in FIG. 12, the fluid fill tubing assembly 418 may simply be a length of nylon tubing (or tubing of another material) combined with a compression fitting which is mounted to the ⅛th NPT threaded hole 908 on the top of the vent-sipper manifold 406. The fluid fill tubing assembly 418 may provide a pathway for fluid insertion from the top of the priming station enclosure down to the fluid reservoir 706. However, in some alternative embodiments (e.g., embodiments in which sufficient fluid can be introduced initially into the cartridge 200), the priming station 100 may not include a fluid fill tubing assembly.

Waste Manifold

In some embodiments, for ease of assembly and machinability, the top assembly 302 may include separate waste and vent-sipper manifolds 406 and 408. In some embodiments, the designs of the waste manifold 408 may be similar to that of the vent-sipper manifold 406; therefore, a discussion of some of the common features is not repeated here.

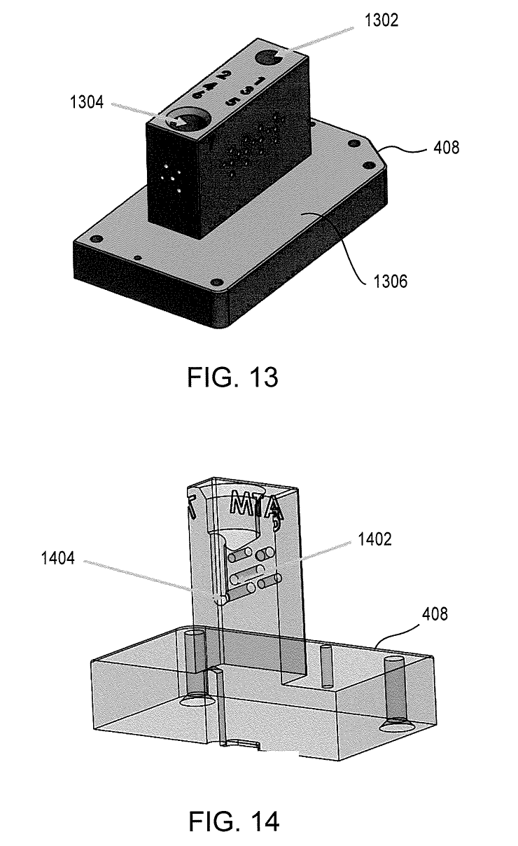

FIGS. 13 and 14 illustrate a perspective view and a see-through view, respectively, of a waste manifold 408 according to one non-limiting embodiment. In some embodiments, as shown in FIG. 13, the waste manifold 408 may include a vacuum line hole 1302 (e.g., a 1/16th NPT threaded hole). In some embodiments, in the location of the fluid fill hole 908 on the vent-sipper manifold 406 for a sipper reservoir valve, the waste manifold 408 may have a hole 1304 for a valve to open the vacuum line 1402 up to the atmosphere. Similar to the other valve mounting locations, in some non-limiting embodiments, the normally open channel may be a dead end, and the common channel may connect to the common vacuum line; however, the normally closed channel in the waste manifold 408 may connect to the atmosphere. This atmospheric channel 1404 may open into the hole 1304, which may be a threaded hole, in the top of the waste manifold 408 where a screw-in air filter may be attached. In some non-limiting embodiments, the chamfer around this threaded hole 1304 may be included to interface with the o-ring on the sealing surface of the filter.

In some embodiments, to allow assembly of the filter with the waste manifold 408 prior to assembly of the waste manifold 408 with the manifold frame 416, the filter may be mounted to the top of the waste manifold 408. In some non-limiting embodiments, the atmospheric valve may be rotated so the normally closed channel can extend straight upward to the filter as shown in FIG. 14. In some non-limiting embodiments, the valve location labels ATM, 8, and 7 may be on the side surfaces of the waste manifold 408 to allow room for the screw-in filter. Additionally, the valve mounting locations may be such that the waste manifold subassembly can be inserted into the manifold frame 416 without interference with waste valves 2, 4, 6, and 8, and the ATM valve.

In some embodiments, as shown in FIG. 13, the waste manifold 408 may include a gasket sealing surface 1306, which may be the sealing surface for a waste manifold gasket 414 (see FIGS. 4 and 20).

Air Filter

In some embodiments, as illustrated in FIG. 4, the top assembly 302 may include an air filter 424 to keep dust and debris from entering the atmospheric channel 1404 of the waste manifold 408 (see FIG. 14). The air filter 424 may protect the system from foreign matter, which could cause a valve to leak, eventually build up and clog the atmospheric channel 1404, or clog the hydrophobic filter 108 (see FIG. 1). In some embodiments, the air filter 424 may have a large surface area that reduces flow resistance. In some non-limiting embodiments, the air filter 424 may be a screw-in air filter.

In some embodiments, the filter housing may include an o-ring, which may create a good seal with the surface of the waste manifold 408. Though the air filter 424 may slightly decrease flow through the vacuum pump 110 during the blowout cycle, the advantage of filtration may be worth the slightly decreased air flow. In some non-limiting embodiments, the blowout time may be extended to compensate for the slightly decreased air flow.

Valves

In some embodiments, one or more of the valves 422 is a saline compatible valve. In some non-limiting embodiments, one or more of the valves 422 at the sipper location, which see the most use and the most fluid (e.g., DI water), are saline compatible valves 422. However, this is not required, and, in some alternative embodiments, non-saline compatible valves may be used.

In some embodiments, one or more of the valves 422 may be 3-way valves used as 2-way valves. However, this is not required, and, in some alternative embodiments, one or more of the valves 422 may be 2-way valves.

Manifold Frame

In some embodiments, the manifold frame 416 may be the chassis that supports the vent-sipper manifold 406 and the waste manifold 408 along with several other components in the priming station 100.

In some embodiments, the structure of the manifold frame 416 may be based around the two manifolds 406 and 408 and the manifold gasket 410. FIG. 15 illustrates a bottom view of the manifold frame 416 according to one non-limiting embodiment, and FIG. 16 illustrates a top view of the vent-sipper and waste manifolds 406 and 408 according to one non-limiting embodiment.

As shown in FIG. 15, the manifold frame 416 may include a gasket sealing surface 1602. During assembly, the manifolds 406 and 408 may slide up into the central cavity of the manifold frame 416 such that the gasket sealing surface 1602 of the manifold frame 416 is coincident with the gasket sealing surfaces 902 and 1306 of the manifolds 406 and 408. In some embodiments, two permanent gaskets (i.e., vent-sipper manifold gasket 412 and waste manifold gasket 414) may create a seal between the manifolds 406 and 408 and the manifold frame 416. As shown in FIG. 15, the manifold frame 416 may include two ridges 1604 that support the gaskets 412 and 414, which seal against the gasket sealing surfaces 902 and 1306 of the manifolds 406 and 408 shown in FIG. 16. In some embodiments, the ridges 1604 may be wide enough at all points to allow the permanent gaskets 412 and 414 to expand outward when compressed.

In some embodiments, as shown in FIG. 15, the manifold frame 416 may include a middle support bar 1606. In some embodiments, in order to keep all the vent channels a similar length and all the waste channels a similar length, the valve support blocks of the two manifolds 406 and 408 may be centered over the associated wells. As a result, spacing for the middle support bar 1606 of the manifold frame 416 may be limited. In some embodiments, to maintain a seal over the cartridge 200, a manifold parting line 1608 (see FIG. 16) may be kept inside the sealed area-between the two permanent gaskets 412 and 414 that seal on the middle support bar 1606.

In some embodiments, as shown in FIG. 15, the manifold frame 416 may include dowel pin holes and slots 1610 to align the manifold frame to the manifolds 406 and 408.

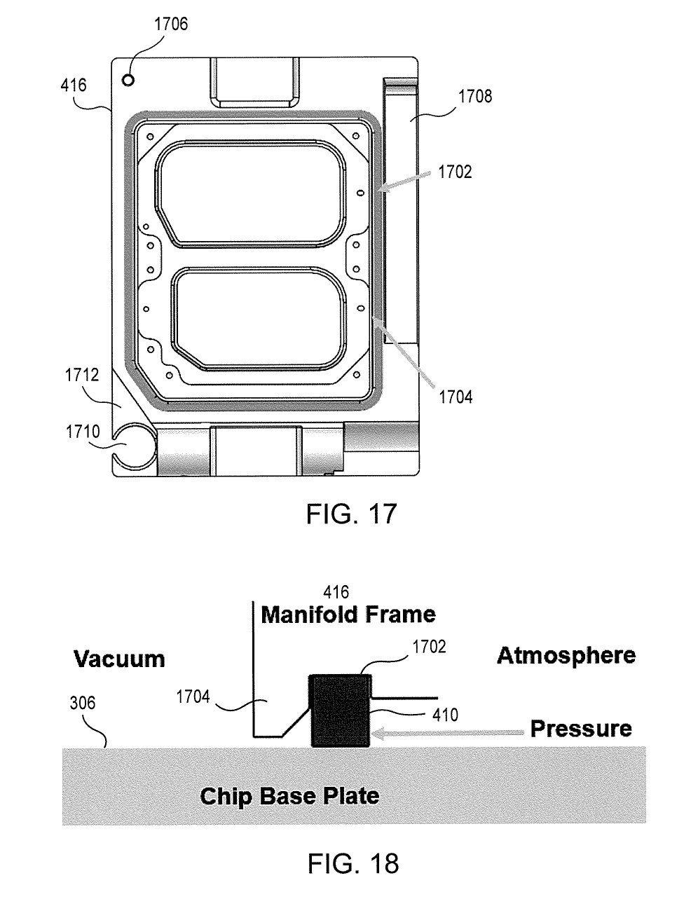

FIG. 17 illustrates a bottom view of the manifold frame 416 according to one non-limiting embodiment. As shown in FIG. 17, the bottom surface of the manifold frame 416 may contain a recession 1702 and support ridge 1704 for the manifold gasket 410. The manifold gasket 410 may allow a vacuum to be held over the entire cartridge 200.

FIG. 18 illustrates a cross-sectional view of the manifold frame 416, manifold gasket 410, and chip base plate 306 according to one non-limiting embodiment. In some embodiments, the gasket recession 1702 may mitigate gasket buckling when a vacuum is pulled. In some embodiments, as shown in FIG. 18, the support ridge 1704 may be designed such that any buckling causes the manifold gasket 410 to wedge against the chip base plate 306 and create a better seal instead of creating a leak.

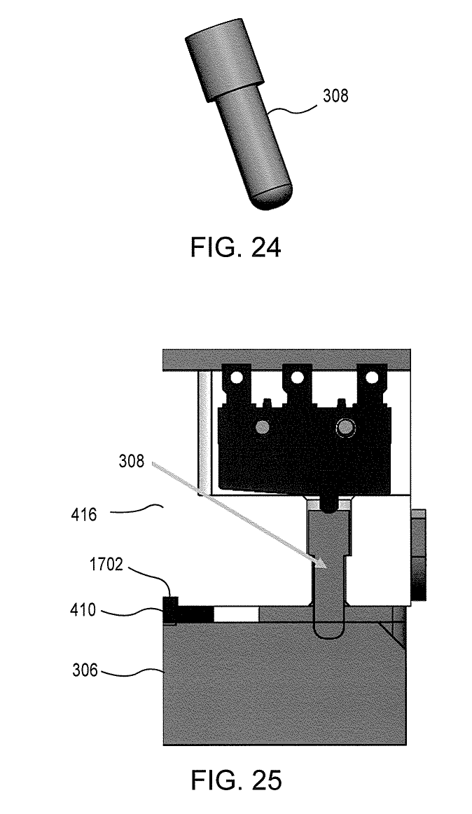

As shown in FIG. 17, in some embodiments, the manifold frame 416 may include a through hole 1706 for a limit switch extension 308 (see FIGS. 3 and 24). In some embodiments, the top and bottom edges of this limit switch extension through hole 1706 may have been chamfered to reduce the risk of catching the limit switch extension 308 and causing the door closure indicator 3502 to remain closed. In some embodiments, the manifold frame 416 may include a through hole 1710 for routing cables through from the top assembly 302 to the printed circuit board (PCB) 106 in the opposite side of the priming station 100 (see FIG. 1). The manifold frame 416 may include a flange 1712 around the cable transfer through hole 1710, and the cable transfer flange 1712 may protect against ingress. In some embodiments, the manifold frame 416 may include a gas spring flange 1708, which may cover the area above the gas spring 310 in the priming manifold assembly 102 to protect against ingress.

Manifold Gasket

FIG. 19 illustrates a bottom view of the manifold gasket 410 on the manifold frame 416 according to one embodiment. In some embodiments, the manifold gasket 410 may create a seal between the chip base plate 306 in the priming manifold assembly 102 and the manifold frame 416. In some embodiments, the manifold gasket 410 may be adhered to the manifold frame 416. The manifold gasket 410 may allow the system to hold a vacuum over the entire cartridge 200 to equalize the vacuum level between the sipper fluid reservoir 706 and the area around the U-chip 214, which may decrease stresses on the U-chip 214. Equalizing the vacuum between the cartridge 200 and the sipper fluid reservoir 706 may also eliminate the pressure differential on the thin portion of the vent-sipper gasket 402, which would otherwise attempt to push this portion of the vent-sipper gasket 402 into the sipper fluid reservoir 706.

Vent-Sipper Manifold Gasket and Waste Manifold Gasket

FIG. 20 illustrates a bottom view of the vent-sipper manifold gasket 412 and the waste manifold gasket 414 on the manifold frame 416 according to one embodiment. In some embodiments, the vent-sip manifold gasket 412 may create a seal between the manifold frame 416 and the vent-sipper manifold 406, and the waste manifold gasket 414 may create a seal between the manifold frame 416 and the waste manifold 408. Although the embodiment illustrated in FIG. 20 includes separate gaskets 412 and 414, this is not required. In some alternative embodiments, the vent-sipper manifold gasket 412 and the waste manifold gasket 414 may be combined into a single gasket.

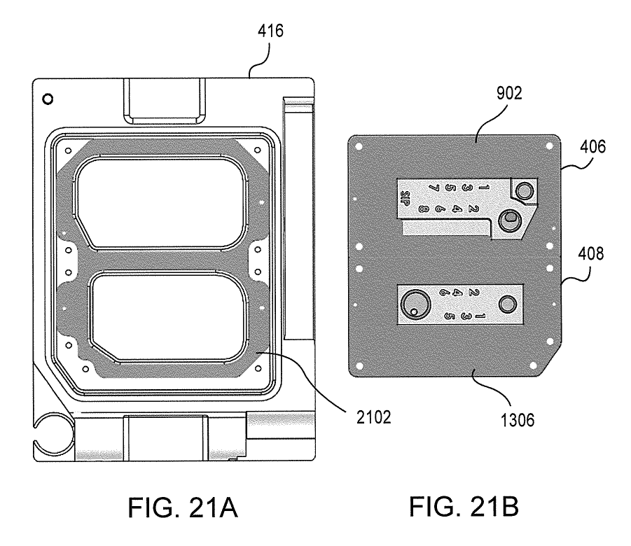

FIG. 21A illustrates a bottom view of the manifold frame 416 according to one non-limiting embodiment, and FIG. 21B illustrates a top view of the vent-sipper and waste manifolds 406 and 408 according to one non-limiting embodiment. In some embodiments, the vent-sip manifold gasket 412 may be permanently compressed between the gasket sealing surface 902 of the vent-sipper manifold 406 and the surface 2102 of the manifold frame 416 when the vent-sipper manifold 406 is assembled with the manifold frame 416. Similarly, the waste manifold gasket 414 may be permanently compressed between the gasket sealing surface 1306 of the waste manifold 408 and the surface 2102 of the manifold frame 416 when the waste manifold 408 is assembled with the manifold frame 416. Therefore, in some non-limiting embodiments, the vent-sip and waste manifold gaskets 412 and 414 may not be adhered to the manifold frame 416.

Material Selection

Gasket Material

In some non-limiting embodiments, one or more of the vent-sipper gasket 402, waste gasket 404, and manifold gasket 410 may be made of rubber (e.g., a silicone rubber) with adhesive applied to the proper side. In some non-limiting embodiments, one or more of the waste manifold gasket 414 and vent-sip manifold gasket 412 may be made of rubber (e.g., silicone rubber) without an adhesive backing.

Vent-Sipper Manifold and Waste Manifold Material

In some non-limiting embodiments, one or more of the manifold 406 and waste manifold 408 may be made of a thermoplastic polymer (e.g., polyether ether ketone (PEEK)). However, this is not required, and, in some alternative embodiments, one or more of the vent-sipper manifold 406 and waste manifold 408 may be made from a different material (e.g., another engineering plastic such as, for example, stereolithography (SLA) resin, watershed ABS or other). The vent-sipper manifold 406 and waste manifold 408 make up the “liquid paths” of the priming station 100.

Priming Manifold Assembly

The purpose of the priming manifold assembly 102, which is shown in FIGS. 1 and 3, may be to complete the cartridge interface of the priming station 100. In some embodiments, the priming manifold assembly 102 may provide the bottom support and sealing surface for the cartridge 200 and the top assembly 302. The priming manifold assembly 102 may include mounting locations for a latch 124 and the necessary components to complete the hinge on the priming station door/lid.

As illustrated in FIG. 3, the priming manifold assembly 102 may include one or more of a top assembly 302, a chip base bearing assembly 304 that includes a chip base plate 306, a limit switch extension 308, a gas spring 310, a damper 312, and a damper capture 314. Individual components of the priming manifold assembly 102 are described below:

Chip Base Bearing Assembly

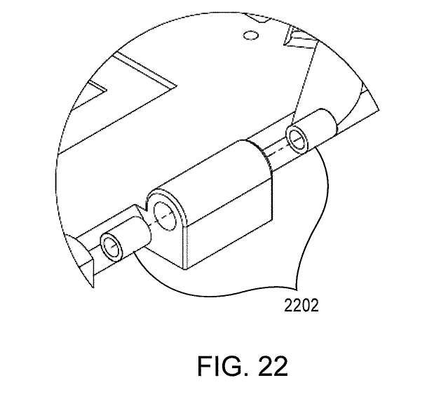

In some embodiments, the chip base bearing assembly may include the chip base plate 306 and one or more (e.g., two) sleeve bearings 2202. FIG. 22 illustrates a perspective view of the sleeve bearings 2202 according to one non-limiting embodiment. As shown in FIG. 22, the sleeve bearings 2202 may be press fit. The bearings 2202 may form the bottom portion of the priming station hinge rotary surface. The bearings 2202 may provide smoother operation of the priming station door and/or may reduce the metal debris that would otherwise be created by cycling the hinge. However, the bearings 2202 are not required, and, in some alternative embodiments, the chip base bearing assembly 304 may not include bearings 2202.

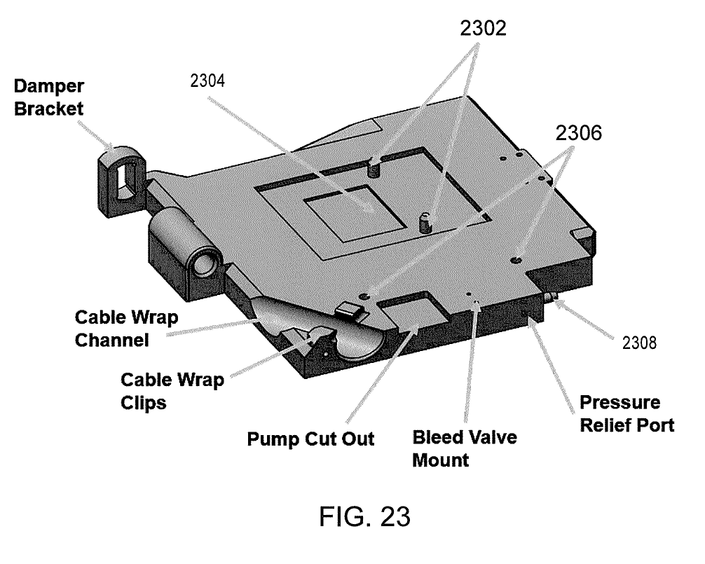

FIG. 23 illustrates a perspective view of the chip base plate 306 according to one non-limiting embodiment. As shown in FIG. 23, in some embodiments, the chip base plate 306 may include one or more (e.g., two) cartridge alignment pins 2302, which may be configured to align the cartridge 200 with the priming station 100. In some embodiments, the chip base plate 306 may include a small cut out 2304 between the alignment pins 2302 to allow room for a flex circuit of the cartridge 200, which may extend down below the cartridge bottom surface. In some embodiments, the chip base plate 306 may include one or more (e.g., two) through holes 2306, may be oversized and may allow easier assembly of the enclosure cover 120, which may be made of, for example and without limitation, sheet metal.

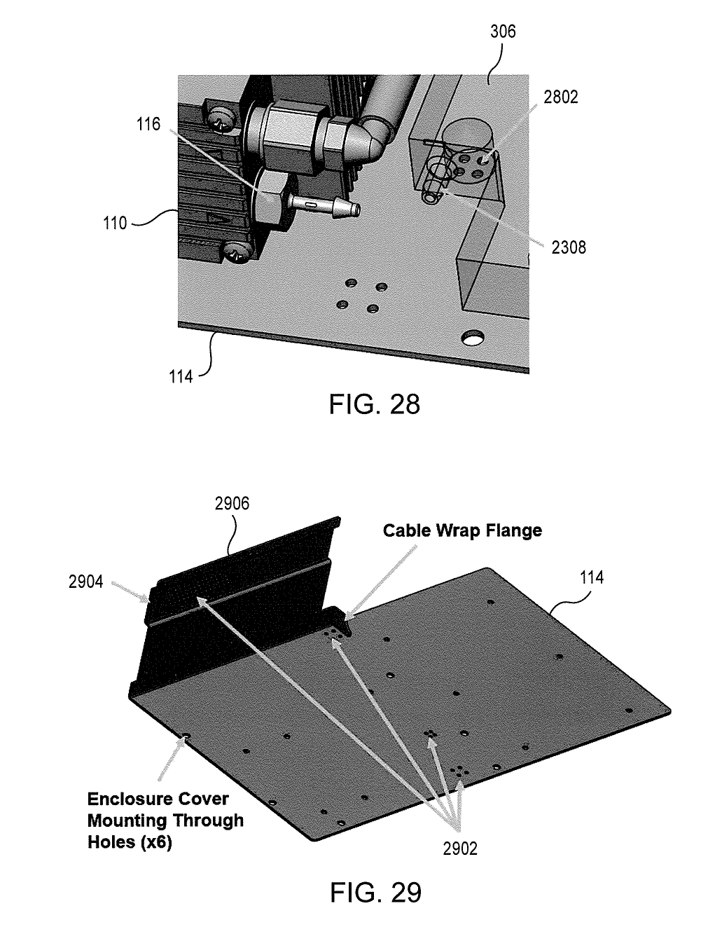

In some embodiments, the chip base plate 306 may include a muffler port 2308 on the chip base plate 306, which may be designed to connect with muffler tubing exiting the vacuum pump 110. The vacuum port 2308 may direct air and fluid out the bottom of the priming station 100 through holes 2802 in the priming station base plate 114 (see FIG. 28). In some non-limiting embodiments, the chip base plate 306 may include a small pressure relief port 2310 out of the side of the exhaust channel, which may mitigate the risk of a damaging pressure spike in the vacuum pump 110 if the holes 2802 in the bottom of the priming station base plate 114 for fluid and air to exit the vacuum pump 110 become blocked.

Limit Switch Extension

FIG. 24 is a perspective view of a limit switch extension 308 according to one non-limiting embodiment. In some non-limiting embodiments, as shown in FIG. 24, the limit switch extension 308 may be a simple thermoplastic polymer (e.g., PEEK) component that actuates the door closure indicator 3502, which may be a limit switch, to indicate priming station door closure.

FIG. 25 is a cross-sectional view of the limit switch extension 308, manifold frame 416, and chip base plate 306 according to one non-limiting embodiment. In some embodiments, as shown in FIG. 25, the flange on the limit switch extension 308 may keep the part locked between the manifold frame 416 and the door closure indicator 3502, which may be part of a chip detect cable, and the bottom tip of the limit switch extension 308 may be rounded to reduce wear and stress from contact with the chip base plate 306. In some embodiments, the limit switch extension 308 may enable the door closure indicator 3502 to be enclosed behind the manifold frame 416, which may create a more robust and aesthetic solution.

Some embodiments of the priming station 100 do not include a limit switch extension 308. For example, as an alternative, the priming station 100 may have a longer waterproof switch interact directly with the chip base plate 306.

Priming Station Hinge

The hinge of the priming station door may be configured for proper sealing over the cartridge 200, for maintaining clearance between the enclosure and manifold cover 122, and/or for ensuring safety to the user. In some embodiments, to mitigate any door closing hazard, the priming manifold assembly 102 may include damper 312 and a gas spring 310 (e.g., a 5 lb gas spring). The damper 312 may be, for example and without limitation, a 1 N-m rotary vane damper. In some non-limiting embodiments, the gas spring 310 may provide door opening assistance.

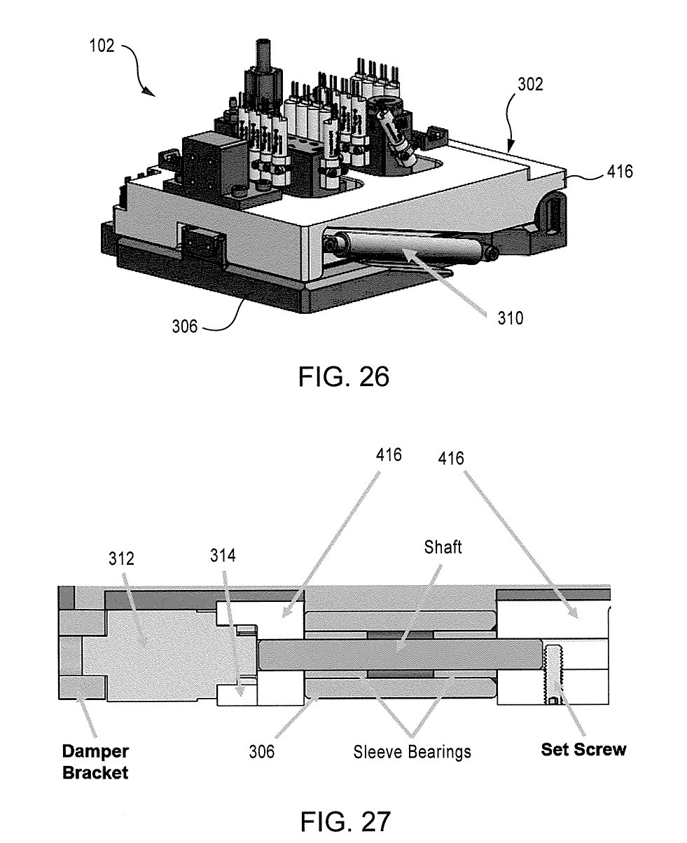

FIG. 26 is a perspective view of an assembled priming manifold assembly 102 according to one non-limiting embodiment. As shown in FIG. 26, the gas spring 310 may be mounted to the side of the chip base plate 306 and the manifold frame 416.

FIG. 27 is a cross-sectional view of the hinge according to one non-limiting embodiment. As shown in FIG. 27, in some non-limiting embodiments, the bottom portion of the hinge may be one piece with the chip base plate 306 and may require no post-machining. In some non-limiting embodiments, the priming manifold assembly 102 may include a damper capture 314, which may mount to the manifold frame 416 to more fully secure the rotating arm of the damper 312. By further constraining the damper 312, the damper capture 314 may reduce the risk of wear on the damper 312 and may maintain the design intent of an on-axis damper.

Cartridge Priming Assembly

As shown in FIG. 1, the priming station 100 may include components in addition to the priming manifold assembly 102. The additional components are referred to as the cartridge priming assembly. The components of the cartridge priming assembly may include, for example, one or more of a pump cable assembly 104 (including the vacuum pump 110), a priming system PCB 106, a hydrophobic filter 108, pump anti-vibration silicone pad 112, a priming station base plate 114, one or more fittings (e.g., pump outlet fitting 116), a membrane panel 118, enclosure cover 120, manifold cover 122, latch 124, vacuum tubing, a plug 126, and grommet 128. In some embodiments, the components of the cartridge priming assembly do not interface directly with the cartridge 200. Individual components of the cartridge priming assembly are described below:

Pump Cable Assembly

A non-limiting embodiment of the pump cable assembly 104 is shown in FIG. 1. In some embodiments, the pump cable assembly 104 may include the vacuum pump 110 and one or more (e.g., three) cabling connectors that interface with the priming station PCB 106. In some embodiments, the vacuum pump 110 may provide the low absolute pressures for degassing fluid and priming a cartridge 200. In some embodiments, the vacuum pump 110 may have a plastic head. However, this is not required, and, in some alternative embodiments, a different pump (e.g., an aluminum head diaphragm pump) may be used.

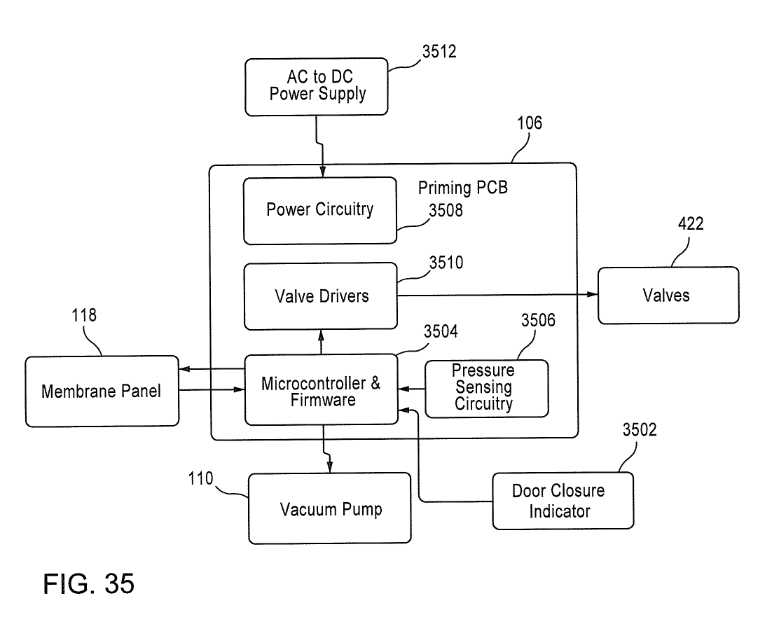

In some embodiments, to protect the vacuum pump 110 and PCB pressure sensing circuitry 3506 (see FIG. 35) from any fluid traveling through the vacuum lines from the manifolds 406 and 408, the cartridge priming assembly may include a hydrophobic filter 108 between the vacuum pump 110 and the manifolds 406 and 408, upstream of the pressure sensing circuitry 3506. In some embodiments, the cartridge priming assembly may include a pump anti-vibration silicone pad 112 that may be included between the pump 110 and the priming station base plate 114 along with o-rings compliant material between the pump 110 and its mounting nuts to dampen the pump vibration.

FIG. 28 illustrates a perspective view of a portion of the priming station base plate 114 according to one non-limiting embodiment. In some embodiments, an NPT or other type of fitting may be installed in the vacuum pump inlet. In some embodiments, the cartridge priming assembly may include a fitting 116 (e.g., an NPT or other type of fitting) and muffler tubing installed in the pump outlet to attenuate the noise output of the vacuum pump 110 and to direct condensation and humidity out of the priming station 100. The muffler tubing (not shown in FIG. 28) may connect the pump outlet fitting 116 to the muffler port 2308 on the chip base plate 306, which may port out of the priming station 100 through the base plate 114 via a base exhaust 2802. In some embodiments, to ensure condensation will not pool in the muffler tubing, the chip base plate muffler port 2308 may be lower than the pump outlet fitting 116, and the muffler tubing may be sized such that it does not sag.

Membrane Panel

In some embodiments, the membrane panel 118 may be a user interface. The membrane panel 118 may inform the user of the priming station status. In some non-limiting embodiments, the membrane panel 118 may allow the user to press “Run” to start or continue the priming process after fluid has been loaded into the priming station 100.

Priming Station Base Plate

FIG. 29 illustrates a perspective view of the priming station base plate 114 according to one non-limiting embodiment. The priming station base plate 114 may be designed to support components of, and form the base of the priming station 100. In some non-limiting embodiments, the priming station base plate 114 may be made of stainless steel (e.g., 0.059 in type 304 stainless steel). In some non-limiting embodiments, one or more of the priming manifold assembly 102, vacuum pump 110, PCB 106, and enclosure cover 120 may mount directly to the priming station base plate 114.

In some embodiments, the priming station base plate 114 may include one or more drain holes 2902, which may mitigate condensation, heat, and fluid egress and ingress in and from the priming station 100. In some embodiments, the priming station base plate 114 may include a PCB mounting wall 2906, which may include a louver jog 2904 designed to sit almost flush with the enclosure cover 120 to prevent direct ingress through the air flow louver 3002 of the enclosure cover 120.

Enclosure Cover

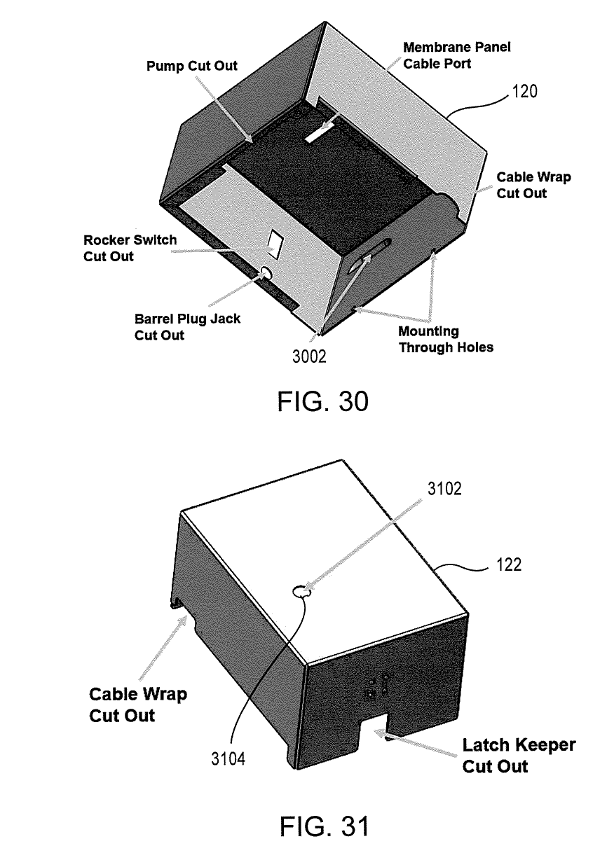

FIG. 30 illustrates a perspective view of the enclosure cover 120 according to one non-limiting embodiment. In some embodiments, the enclosure cover 120 may surround the vacuum pump 110, PCB 106, and hydrophobic filter 108 while also providing support for the membrane panel 118. In some non-limiting embodiments, the enclosure cover 120 may include the air flow louver 3002 on the back face of the enclosure cover 120, positioned above the DC to DC converter on the PCB 106 to allow air flow as necessary for cooling.

Manifold Cover

FIG. 31 illustrates a perspective view of the manifold cover 122 according to one non-limiting embodiment. In some embodiments, the manifold cover 122 may surround the components of the priming manifold assembly 102. In some embodiments, the manifold cover 122 may provide support for the plug 126 and grommet 128, which may be a threaded grommet. In some embodiments, as shown in FIG. 31, the manifold cover 122 may include a grommet cutout 3102 for the grommet 128. In some non-limiting embodiments, the grommet cutout 3102 may include an alignment key 3104, which may maintain consistent grommet and plug orientation between devices.

Plug

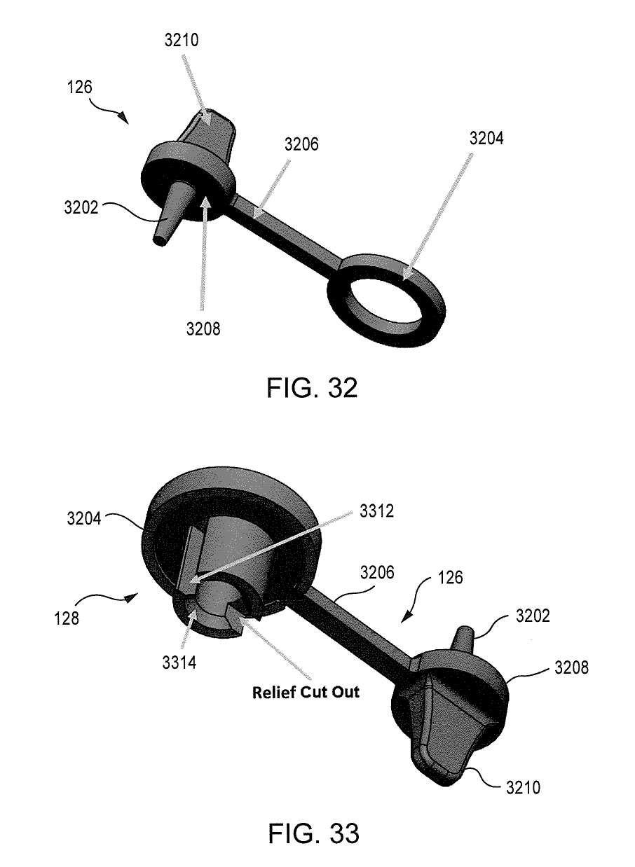

FIG. 32 illustrates a perspective view of the plug 126 according to one non-limiting embodiment. In some embodiments, the plug 126 may include a tapered plug portion 3202 that may be used to seal the fluid fill port 130 formed by the grommet 128 in the grommet cut out 3102 and the fluid fill tubing assembly 418 on the top of the priming station 100. In some non-limiting embodiments, the plug 126 may include a hard stop flange 3208 around to the top of the tapered plug portion 3202 to prevent over insertion. In some non-limiting embodiments, the diameter of the tapered plug portion 3202 and the height of the hard stop flange 3208 may be such that, when the flange 3208 contacts the top surface of the grommet 128, the plug 126 is inserted properly and creates a seal. In some non-limiting embodiments, the taper of the tapered plug portion 3202 may be shallow enough to create a good sealing area with the fluid fill tubing assembly 418.

In some non-limiting embodiments, the plug 126 may include a holding tab 3210 on top of the hard stop flange 3208. The holding tab 3210 may ensure proper removal of the plug 126. During removal, the tab 3210 may allow the user to pull the plug 126 straight up instead of needing to peel the plug 126 out using the hard stop flange 3208, which could rip the plug off of the flange. However, the holding tab 3210 is not required, and, in some alternative embodiments, the plug 126 may not include the tab 3210. In some non-limiting embodiments, the plug 126 may be cast with silicone. However, this is not required, and, in some alternative embodiments, different materials may be used for the plug 126.

In some non-limiting embodiments, the plug 126 may include an attachment ring 3204 and connecting arm 3206, which may attach the plug 126 to the grommet 128 to make the plug 126 difficult to lose.

Grommet

In some non-limiting embodiments, the grommet 128 may be designed to cleanly mate the fluid fill tubing assembly 418 to the top surface of the manifold cover 122. FIG. 33 illustrates a perspective view of the plug 126 and grommet 128 according to one non-limiting embodiment. In some non-limiting embodiments, the grommet 128 may hold the plug 126 in place. In some non-limiting embodiments, when assembled, the attachment ring 3204 (or some other feature to retain the grommet) of the plug 126 may be captured between the grommet 128 and the manifold cover 122. In some non-limiting embodiments, to maintain consistent assembly, the grommet 128 may include a slot 3312 to align with a key 3104 in the grommet cut out 3102 of the manifold cover 122.

In some embodiments, the inner diameter of the grommet 128 may be designed to fit tightly around the fluid fill tubing assembly 418 to reduce fluid ingress between the two components. In some non-limiting embodiments, the grommet 128 may include a chamfer 3314 that may aid in alignment with and protection of the fluid fill tubing assembly 418 during assembly of the manifold cover 122 over the priming manifold assembly 102.

Latch

In some embodiments, the latch 124 may apply the force necessary to compress the vent-sipper gasket 402, waste well gasket 404, and manifold gasket 410 onto the cartridge 200 and chip base plate 306.

Gasket Compression

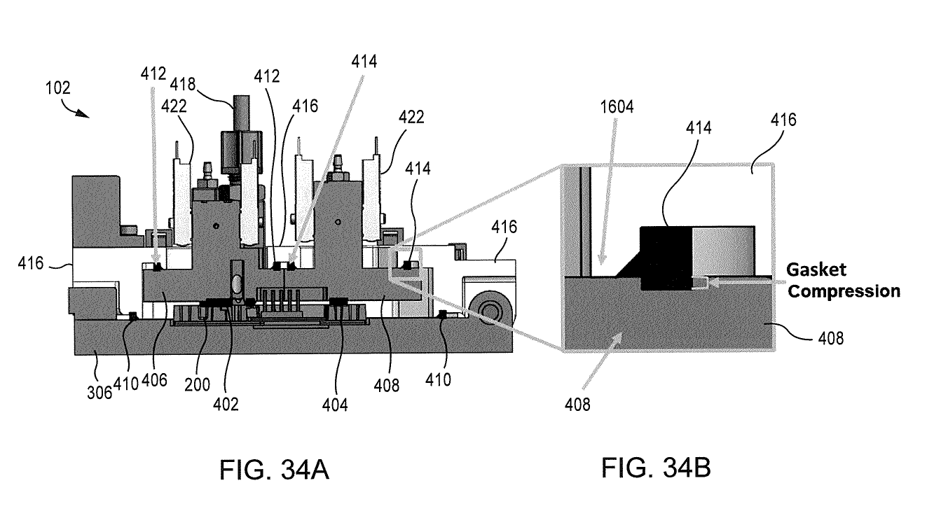

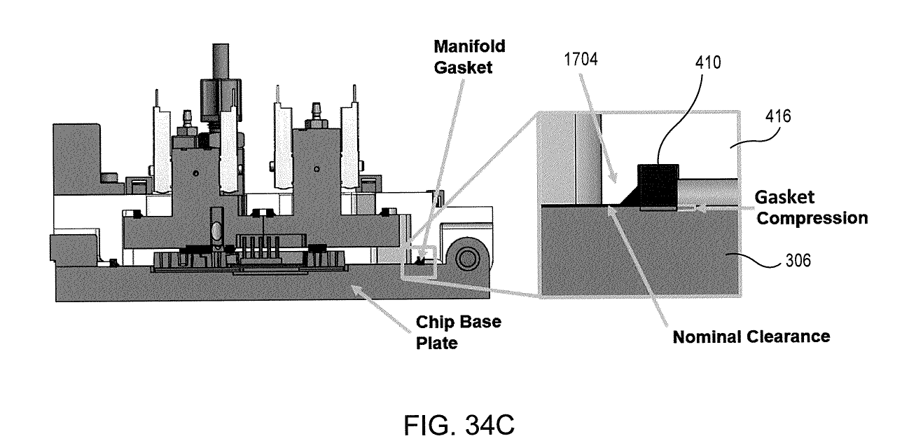

FIG. 34A is a cross-sectional view of the priming manifold assembly 102 according to one non-limiting embodiment. FIGS. 34B and 34C are enlarged cross-sectional views of the compressed waste manifold gasket 414 and the compressed manifold gasket 410, respectively, according to some non-limiting embodiments. In some non-limiting embodiments, the priming station 100 may be designed for gasket compression at a certain percentage (e.g., 20% gasket compression) upon latching for sealing successfully over the cartridge 200.

In some non-limiting embodiments, the two cartridge interface gaskets (i.e., the vent-sipper gasket 402 and waste well gasket 404) may be designed for a first compression percentage upon latching. In one non-limiting embodiment, the first compression percentage may be, for example and without limitation, 20% compression upon latching (see FIG. 34B). In some embodiments, obtaining 20% compression may be straightforward for the vent-sipper and waste well manifold gaskets 412 and 414, which may be permanently assembled between well toleranced surfaces on the manifolds 406 and 408 and the manifold frame 416. In some non-limiting embodiments, as shown in FIG. 34B, the gasket ridges 1604 on the manifold frame 416 may hard stop against the manifolds 406 and 408 during assembly to target the first compression percentage (e.g., 20% compression) avoid over-compression of the two gaskets 412 and 414.

In some non-limiting embodiments, the manifold gasket 410 may be designed for a second compression percentage upon latching. In various embodiments, the second compression percentage may be the same as, less than, or more than the first compression percentage. In one non-limiting embodiment, the second compression percentage may be, for example and without limitation, 10% compression upon latching (see FIG. 34C). In embodiments where the second compression percentage is lower than the first compression percentage, the lower second compression percentage is lower than the latching force required for the door of the priming station 100.

In some embodiments, because the priming station 100 pulls a vacuum over the entire cartridge area during the priming process, as long as a slight seal with the manifold gasket 410 is achieved, the resulting vacuum force may pull the priming station door down slightly to increase compression of the manifold gasket 410 along with the vent-sipper and waste well manifold gaskets 412 and 414. In some embodiments, downward motion of the door after latching may be limited in the rear by the tightly toleranced hinge and in the front by the manifold gasket ridge 1704 on the manifold frame 416. In some non-limiting embodiments, this manifold gasket ridge 1704 may be designed and toleranced with the hinge to prevent interference between the ridge 1704 and the chip base plate 306.

Vacuum Paths

In some non-limiting embodiments, one or more of the fittings (e.g., barbed and NPT fittings) included in the priming station may be made of a material that resists corrosion (e.g., a polymeric material) because priming fluid (e.g., deionized water) is regularly pulled through the vacuum lines. In some non-limiting embodiments, one or more of the fittings may be nylon fittings. However, this is not required, and, in some alternative embodiments, one or more of the fittings may be made using a different material (e.g., a non-nylon and/or non-corrosion resistant material such as, for example, brass or stainless steel). In some non-limiting embodiments, the vacuum tubing may be rubber tubing. In some non-limiting embodiments, the vacuum tubing may be vacuum rated such that it will not collapse at deep vacuums.

Priming Station Electrical Design

In some embodiments, the PCB 106 may control one or more of the vacuum pump 110, valves 422, and display (e.g., user LEDs) of the membrane panel 118. In some embodiments, the PCB 106 may sense one or more of ambient pressure, differential pressure, and user input (e.g., user button presses).

FIG. 35 is a functional block diagram illustrating the PCB 106 and components of the priming station 100 with which the PCB 106 interacts according to one non-limiting embodiment. In some embodiments, as illustrated in FIG. 35, the PCB 106 may include one or more of a controller 3504 (e.g., a microcontroller), pressure sensing circuitry 3506, power circuitry 3508, and a valve control circuit 3510. In some embodiments, as illustrated in FIG. 35, the PCB 106 may interact with a door closure indicator 3502, a power supply 3512, valves 422, a vacuum pump 110, and a membrane panel 118. Individual components of the PCB 106 are described below.

Power Supply

In some embodiments, the PCB 106 may be powered from the power supply 3512. In some non-limiting embodiments, the power supply 3512 may be an AC to DC power supply. In one non-limiting embodiment, the power supply 3512 may be a 24V DC power supply, with a maximum output current of 3.25 A.

In some embodiments, the power circuitry 3508 of the PCB 106 may receive power from the power supply 3512 and generate power supply signals for one or more of the valve control circuit 3510, the pressure sensing circuitry 3506, and the controller 3504. For example, in some non-limiting embodiments, the power circuitry 3508 may include a DC-DC converter to generate a power supply signal for the valve control circuit 3510. In one non-limiting embodiment, the DC-DC converter may generate a 6V supply with a maximum current of 2 A.

In some non-limiting embodiments, the power circuitry 3508 may include a linear regulator to provide accurate voltage regulation with low noise for the pressure sensing circuitry 3506. In one non-limiting embodiment, the linear regulator may receive the 6V supply from the DC-DC converter and generate a 5V supply.

In some non-limiting embodiments, the power circuitry 3508 may include a second linear regulator to provide accurate voltage with low-noise for the controller 3504 (e.g., for analog conversion and digital electronics). In one non-limiting embodiment, the second linear regulator may receive the 5V supply from the first linear regulator and generate a 3.3V supply. In some non-limiting embodiments, the power circuitry 3508 may include a voltage supervisor that triggers a reset if output of the first or second linear regulator falls below one or more thresholds. For example and without limitation, the voltage supervisor may trigger a reset if the 5V supply from the first linear regulator falls below 4.75V or if the 3.3V supply from the second linear regulator falls below 3.08V.

Controller

In some embodiments, the controller 3504 of the PCB 106 may handle the control logic of the priming station 100. In some embodiments, the PCB 106 may include a memory (e.g., a flash memory) that provides memory for the priming station 100.

In some embodiments, the controller 3504 may include inputs for one of more of a user input (e.g., a button) of the membrane panel 118, the door closure indicator 3502, differential pressure, and ambient pressure. The user input may be a digital input and may provide a user interface (e.g., for a start/run button of the membrane panel 118). In some non-limiting embodiments, one or more user inputs (e.g., buttons) may be connected to one or more interrupt pins of the controller 3504. The input for the door closure indicator 3502 may be a digital input and may enable the controller 3504 to determine whether the lid (e.g., manifold frame 416 and/or manifold cover 122) of the priming station 100 is closed. The inputs for the differential and ambient pressures may be analog inputs and may be inputs to one or more analog-to-digital converters (ADCs) of the controller 3504. The differential pressure input may enable the controller 3504 to measure the vacuum pressure generated by the vacuum pump 110. The ambient pressure input may enable the controller 3504 to measure the atmospheric pressure.

In some embodiments, the controller 3504 may include outputs for controlling one or more of the valves 422, vacuum pump 110, and display of the membrane panel 118. In some non-limiting embodiments, one or more of the outputs of the controller 3504 may be digital outputs. In some non-limiting embodiments, the outputs of the controller 3504 may include one or more outputs each for controlling when one or more of the valves 422 are on or off. In some non-limiting embodiments, the outputs of the controller 3504 may include one or more outputs each for selecting a drive value for one or more of the valves 422 (e.g., driving with either a spike value of, for example and without limitation, 24V or a hold value of, for example and without limitation, 6V). In some non-limiting embodiments, the outputs of the controller 3504 may include one or more outputs for controlling the vacuum pump 110. In some non-limiting embodiments, the outputs of the controller 3504 may include one or more outputs for controlling the display (e.g., LEDs) of the membrane panel 118 for interfacing with the user (e.g., indicating one or more statuses to the user and/or providing user cues).

In some embodiments, the priming station 100 (e.g., the PCB 106 of the priming station 100) may include one or more oscillators for setting one or more clocks of the controller 3504. In some non-limiting embodiments, the controller 3504 may include a main clock that is set using a first oscillator (e.g., a 20 MHz oscillator). In some non-limiting embodiments, the controller 3504 may include a slow clock that is set using a second oscillator (e.g., a 32.768 kHz oscillator).

In some embodiments, one or more of the controller 3504 and the memory may have one or more reset lines, which may be tied to the voltage supervisor. For example and without limitation, in some non-limiting embodiments, the voltage supervisor may reset one or more of the controller 3504 and the memory if the 5V supply from the first linear regulator falls below 4.75V or if the 3.3V supply from the second linear regulator falls below 3.08V. In some non-limiting embodiments, the priming station 100 may include a switch (e.g., a pushbutton switch) that enables manual reset of one or more of the controller 3504 and the memory.

Vacuum Pump

In some embodiments, the vacuum pump 110 may generate vacuum pressures for priming. In some non-limiting embodiments, the vacuum pump 110 may be powered from the power supply 3512. In some non-limiting embodiments, the vacuum pump 110 may be turned on and off by an output of the controller 3504 of the PCB 106. In some non-limiting embodiments, the pump speed of the vacuum pump 110 may be controlled by a pulse width modulation (PWM) signal from the controller 3504. However, this is not required, and, in some alternative embodiments, the priming station may use only on/off control of the vacuum pump 110 for simplicity.

In some non-limiting embodiments, the vacuum pump 110 may have one or more of a tachometer output for speed control and an error output that signals one or more of overcurrent, over-temperature, and stall conditions. In some embodiments, the controller 3504 may have access to one or more of these output signals.

Valves and Valve Control Circuit

In some embodiments, the valves 422 are used to control pressure and, therefore, fluid movement in a cartridge 200 loaded in the priming station 100. In some non-limiting embodiments, the controller 3504 of the PCB 106 may control the timing of the valve operation.

In some embodiments, the valve control circuit 3510 (i.e., valve driver circuit) may open one or more valves 422 and hold the valves 422. In some non-limiting embodiments, the valve control circuit 3510 may open a valve 422 by applying a voltage spike (24V for 10 ms) to actuate the valve 422 and then reduces the voltage (e.g., to 5.7V) to keep the valve 422 open. In some embodiments, the higher spike voltage may result in extra force actuating the valve 422, which may produce fast and powerful operation.

In some embodiments, the low hold voltage may reduce power dissipation in the valves 422, which may keep the valves 422 at a cooler operating temperature and may reduce long term stress on the components. In some non-limiting embodiments, the controller 3504 may control spike timing to limit spike duration and prevent overheating of the valves 422.

In some embodiments, the valve control circuit 3510 may be controlled by the valve on/off and valve drive value signals from the controller 3504. The one or more valve on/off signals may each control whether any power is supplied to one or more valves 422. The one more valve drive value signals may each control whether the drive voltage for one or more valves 422 is the spike level (e.g., 24V) or the hold level (e.g., 5.7V). In some embodiments, the valve control circuit 3510 may receive the power for the spike level from the power supply 3512. In some embodiments, the power for the hold level may be generated from an output of the power circuitry 3508 (e.g., from output of the DC-DC converter of the power circuitry 3508, which may be a 6V supply).

In some non-limiting embodiments, the valve control circuit 3510 may include two drive circuits each connected to a single valve 422 and two drive circuits each connected to a bank (e.g., eight) of valves 422 in parallel. For example, in some non-limiting embodiments, a first drive circuit of the valve control circuit 3510 may control (in parallel) a bank of valves 422 for the vent wells of the cartridge 200, and a second drive circuit of the valve control circuit 3510 may control a valve 422 for the common sipper fluid reservoir 706 of the vent-sipper manifold 406 (see FIG. 8). In some embodiments, the valves 422 for the vent wells and common sipper fluid reservoir 706 may be mounted on the valve mounting boss 906 of the vent-sipper manifold 406 (see FIG. 9). Similarly, in some non-limiting embodiments, a third drive circuit of the valve control circuit 3510 may control (in parallel) a bank of valves 422 for the waste wells of the cartridge 200, and a fourth drive circuit of the valve control circuit 3510 may control a valve 422 for the atmospheric channel 1404 of the waste manifold 408 (see FIG. 14). In some embodiments, the valves 422 for the waste wells and atmospheric channel 1404 may be mounted on the valve mounting boss of the waste manifold 408 (see FIG. 13).

Pressure Sensing

In some embodiments, the priming station 100 may perform pressure sensing, and pressure measurements may inform whether priming occurs in a cartridge 200. In some non-limiting embodiments, the pressure sensing circuitry 3506 of the PCB 106 may include one or more differential pressure sensors to measure the vacuum pressure generated by the vacuum pump 110. In some non-limiting embodiments, the pressure sensing circuitry 3506 may include one or more ambient pressure sensors to measure the atmospheric pressure. In some non-limiting embodiments, the voltages output by the pressure sensors may correspond to the measured pressure.

In some embodiments, the outputs of one or more of the differential and ambient pressure sensors may be input to the controller 3504. In some non-limiting embodiments, the output of one or more of the differential and ambient pressure sensors may be input to one or more ADCs of the controller 3504. In some non-limiting embodiments, the controller 3504 may convert the readings from the one or more ADCs into pressure.

User Interface: Membrane Panel

In some embodiments, the membrane panel 118 may contain a user input and a display. In some non-limiting embodiments, the user input may be a user input button, and the display may include one or more (e.g., eight) LEDs. The output of the user input may be input to the controller 3504 and may, for example and without limitation, read as a logic LOW when depressed. The display (e.g., eight LEDs) may be controlled by outputs lines from the controller 3504. In some non-limiting embodiments in which the display has LEDs, the LEDs may be powered through a common connection to power circuitry 3508 (e.g., to the second linear regulator of the power circuitry 3508, which may generate, for example, a 3.3V supply).

User Interface: Power Switch

In some embodiments, the priming station 100 may include power switch 132 (e.g., a panel-mount rocker switch) to turn the priming station 100 on and off. An internal cable may connect the switch to the PCB 106.

User Interface: Barrel Plug Connector

In some embodiments, the power supply 3512 may be an external power supply that connects to the priming station 100 through an interface (e.g., a barrel plug interface).

Door Closure Indicator

In some non-limiting embodiments, the door closure indicator 3502 may be used to detect when the lid (e.g., manifold frame 416 and/or manifold cover 122) of the priming station 100 is closed. In some non-limiting embodiments, the door closure indicator 3502 may be a limit switch. However, this is not required, and some alternative embodiments may use a different door closure indicator. In some non-limiting embodiments, the door closure indicator 3502 may generate a logic LOW when the lid is closed.

Priming Station High Level Work Flow

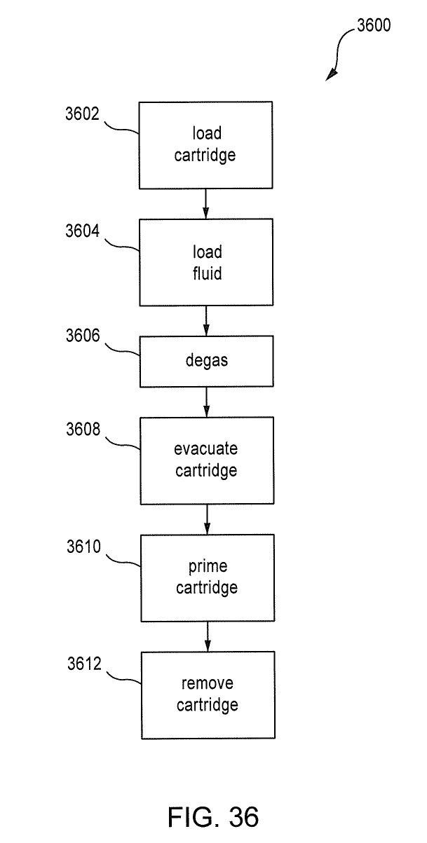

FIG. 36 is a flowchart illustrating a process 3600 for priming a fluidic cartridge 200 according to some non-limiting embodiments. Priming the cartridge 200 may prepare the cartridge 200 for use in an analyzer device. In some non-limiting embodiments, one or more steps of the priming process 3600 may be performed by the priming station 100 acting under the control of the controller 3504 of the PCB 106.

In some embodiments, the priming process 3600 may begin with a step 3602 of loading a cartridge 200 into the priming station 100. In some embodiments, fluid may have been added to the cartridge 200 prior to the cartridge 200 being loaded into the priming station. In some embodiments, the priming process 3600 may include a step 3604 of loading fluid into the priming station 100. However, depending on the initial fluid volume in the cartridge 200, the step 3604 of loading fluid may not be necessary. In some embodiments, the priming process 3600 may include a step 3606 of degassing the fluid. In some embodiments, the priming process 3600 may include a step 3608 of evacuating the cartridge 200. In some embodiments, the priming process 3600 may include a step 3610 of priming the cartridge 200. In some embodiments, the priming process 3600 may include a step 3612 of removing the cartridge 200. In some embodiments, after completion of step 3612, the priming process 3600 may repeat with the loading of another cartridge.

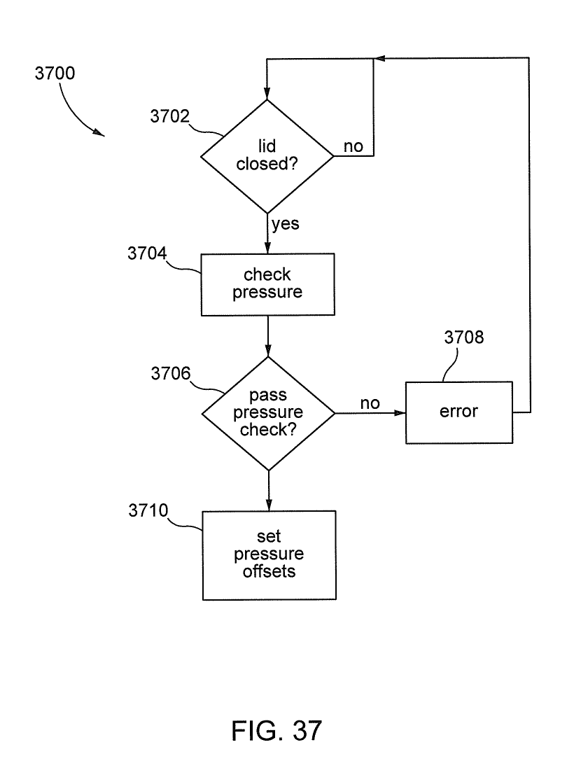

FIG. 37 is a flowchart illustrating a process 3700 that may be performed during the cartridge loading step 3602 of priming process 3600 according to one non-limiting embodiment. As shown in FIG. 37, the cartridge loading process 3700 may include a step 3702 of checking whether the lid (e.g., manifold frame 416 and/or manifold cover 122) of the priming station 100 has been closed. In some embodiments, closing and latching of the lid of the priming station 100 may actuate the door closure indicator 3502 (e.g., a limit switch) to indicate lid closure, which may be detected by the controller 3504. If lid closure is detected, the process may proceed to a step 3704 of performing a pressure check to determine whether a cartridge 200 has been loaded into the priming station 100.

In some embodiments, the pressure check step 3704 may include attempting to pulling a vacuum through the cartridge detect channel 710 of the vent-sipper manifold 406 to determine whether a cartridge 200 has been loaded into the priming station 100. In some non-limiting embodiments, the pressure check step 3704 may include opening a sipper valve (e.g., the valve 422 for the common sipper fluid reservoir 706 of the vent-sipper manifold 406) while leaving the other valves 422 closed and turning the vacuum pump 110 on. If a cartridge 200 is present in the priming station 200, the cartridge 200 will block the cartridge detect channel 710 of the vent-sipper manifold 406, and the vacuum pump 110 will be able to pull a vacuum. However, if no cartridge 200 is loaded in the priming station, the cartridge detect channel 710 will open up to the atmosphere, and the vacuum pump 110 will be unable to pull a vacuum due to the connection to atmosphere through the cartridge detect channel 710. In some non-limiting embodiments, the pressure check step 3704 may include using a differential pressure sensor of the pressure sensing circuitry 3506 to measure the vacuum pressure generated by the vacuum pump 110.

In some embodiments, the cartridge loading process 3700 may include a step 3706 of determining whether the priming station 100 passes the pressure check. In some non-limiting embodiments, the step 3706 may include comparing the measured vacuum pressure generated by the vacuum pump 110 to a target pressure threshold (e.g., −15.75 inches of mercury (in-Hg)). If the measured pressure is below the target pressure threshold, the priming station 100 may determine that a cartridge 200 is present/loaded into the priming station 100, and the cartridge loading process 3700 may proceed to a step 3710 of setting one or more pressure offsets. However, if an amount of time (e.g., 5 seconds) passes, and the measured pressure has not gone below the target pressure threshold, the priming station 100 may determine that a cartridge 200 is not present into the priming station 100, and the cartridge loading process 3700 may proceed to an error handling step 3708.

In some embodiments, the cartridge loading process 3700 may include an error handling step 3708. In some embodiments, the error handling step 3708 may include turning the vacuum pump 110 off and closing the sipper valve. In some embodiments, the error handling step 3708 may include informing the user that an error (e.g., a chip not present error) has occurred (e.g., by using the membrane panel 118 to display an error indication). In some embodiments, the error handling step 3708 may include checking whether the lid of the priming station 100 has been opened. In some embodiments, the cartridge loading process 3700 may proceed back to the lid closure detection step 3702.

In some embodiments, the cartridge loading process 3700 may include a pressure offset setting step 3710. In some embodiments, the pressure offset setting step 3710 may include pulling to the deepest vacuum possible to determine one or more pressure offsets to account for pump degradation and/or ambient pressure. In some non-limiting embodiments, the pressure offset setting step 3710 may include closing the sipper valve while leaving the other valves 422 closed and leaving the vacuum pump 110 on. In some non-limiting embodiments, the pressure offset setting step 3710 may include setting one or more of an ambient pressure offset and a pump degradation offset. In some non-limiting embodiments, the priming station 100 may use the offsets to adjust one or more target pressures (e.g., a waste pressure target). In one non-limiting embodiment, the priming station may adjust one or more target pressures by subtracting one or more of the offsets from one or more of the target pressures.

In some embodiments, in the fluid loading step 3604 of the priming process 3600, the priming station 100 may wait for the user to load priming fluid through the fluid fill port 130 on the top of the priming station 100. In some embodiments, this fluid may be held in the common sipper fluid reservoir 706 of the vent-sipper manifold 406 over the sipper wells of the cartridge 200. In some embodiments, the fluid loading step 3604 may wait until a user indicates that priming fluid has been loaded into the priming station 100 (e.g., by pressing a start/run button of the membrane panel 118). In some embodiments, the fluid loading step 3604 may alternatively or additionally include waiting for a fluid level detector to indicate that a sufficient amount of fluid has been loaded into the device. In some alternative embodiments, the fluid may be loaded automatically into the priming station 100 instead of requiring the user to manually load the fluid. In some embodiments, the fluid loading step 3604 may not be necessary because enough fluid may be present in the cartridge 200 initially.

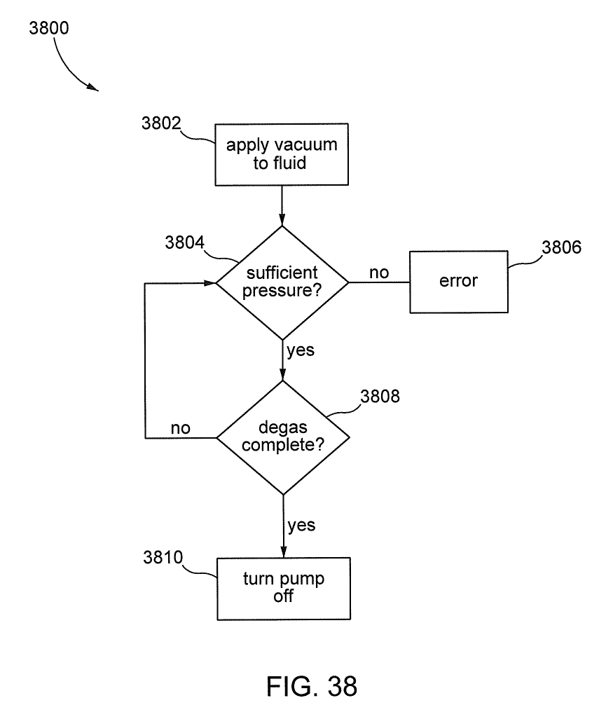

In some embodiments, after fluid is loaded into the common sipper fluid reservoir 706 of the priming station 100, the priming process 3600 may proceed to the fluid degassing step 3606. FIG. 38 is a flowchart illustrating a process 3800 that may be performed during the fluid degassing step 3606 of the priming process 3600 according to one non-limiting embodiment. As shown in FIG. 38, the fluid degassing process 3800 may include a step 3802 of pulling a vacuum over the common sipper fluid reservoir 706 to degas the fluid before priming. In some non-limiting embodiments, the step 3802 may include opening the sipper valve and turning on the vacuum pump 110.

In some embodiments, the fluid degassing process 3800 may include a step 3804 of checking whether the applied vacuum is sufficient for degassing the fluid. In some non-limiting embodiments, the pressure checking step 3804 may include using a differential pressure sensor of the pressure sensing circuitry 3506 to measure the vacuum pressure generated by the vacuum pump 110. In some non-limiting embodiments, the checking step 3804 may include comparing the measured vacuum pressure generated by the vacuum pump 110 to a target degassing pressure threshold (e.g., −27.25 in-Hg, −27 in-Hg, or −26.75 in-Hg). If the measured pressure is above the target degassing pressure threshold, the priming station 100 may determine that the applied vacuum is insufficient for degassing the fluid, and the fluid degassing process 3800 may proceed to an error handling step 3806. However, if the measured pressure is not above the target degassing pressure threshold, the fluid degassing process 3800 may proceed to a step 3808 to check whether the fluid degassing is complete.

In some embodiments, the fluid degassing process 3800 may include an error handling step 3806. In some embodiments, the error handling step 3806 may include turning the vacuum pump 110 off. In some embodiments, the error handling step 3806 may include informing the user that an error (e.g., an insufficient pressure error) has occurred (e.g., by using the membrane panel 118 to display an error indication). In some non-limiting embodiments, the error handling step 3806 may include opening all of the valves 422, waiting for an amount of time (e.g., 10 seconds), and then closing all of the valves 422.

In some embodiments, the fluid degassing process 3800 may include a step 3808 of checking whether the fluid degassing is complete. In some non-limiting embodiments, checking whether the fluid degassing is complete may include checking whether a degas time (e.g., a time within the range of 3 min to 8 min such as, for example without limitation, 7 min 15 sec) has expired. However, this is not required, and, in some alternative embodiments, the step 3808 may determine whether degassing is complete in another manner (e.g., measuring dissolved gasses in the fluid using, for example and without limitation, an oxygen meter, and determining that degassing is complete when the measurement indicates that dissolved gasses are below a target level).

In some embodiments, if fluid degassing is determined to be not complete in step 3808, the fluid degassing process 3800 may proceed back to the pressure checking step 3804. However, in some embodiments, if fluid degassing is determined to be complete in step 3808, the fluid degassing process 3800 may proceed to a step 3810, in which the vacuum pump 110 may be turned off. In some embodiments, the step 3810 may include closing the sipper valve.

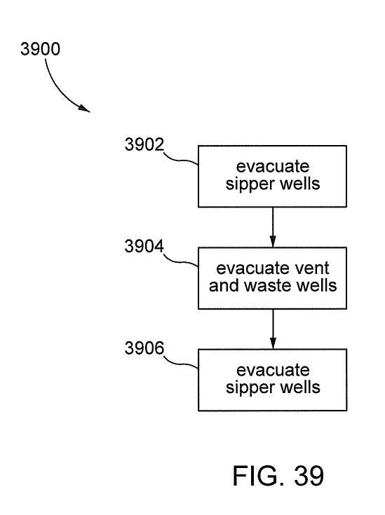

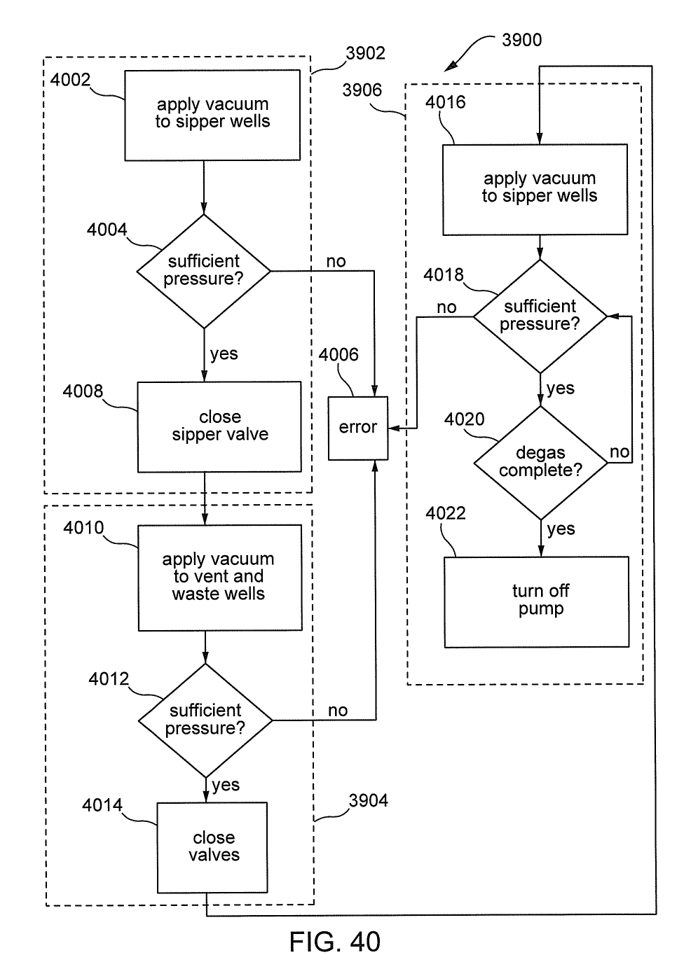

FIG. 39 is a flowchart illustrating an alternative process 3900 that may be performed during the fluid degassing step 3606 of priming process 3600 according to one non-limiting alternative embodiment. As shown in FIG. 39, the alternative fluid degassing process 3900 may include one or more of a step 3902 of evacuating the sipper wells of the cartridge 200, a step 3904 of evacuating the vent and waste wells of the cartridge 200, and a step 3906 of evacuating the sipper wells of the cartridge 200.

FIG. 40 is a flowchart illustrating the alternative fluid degassing process 3900 in more detail. As shown in FIG. 40, in some non-limiting embodiments, the first sipper well evacuation step 3902 may include one or more of steps 4002, 4004, and 4008. In some non-limiting embodiments, the vent and waste well evacuation step 3904 may include one or more of steps 4010, 4012, and 4014. In some non-limiting embodiments, the second sipper well evacuation step 3906 may include one or more of steps 4016, 4018, 4020, and 4022.

As shown in FIG. 40, the first sipper well evacuation step 3902 may include a step 4002 of applying a vacuum to the sipper wells of the cartridge 200. In some non-limiting embodiments, the step 4002 may include opening the sipper valve and turning on the vacuum pump 110.

In some embodiments, the first sipper well evacuation step 3902 may include a step 4004 of checking whether the applied vacuum is sufficient for evacuating the sipper wells. In some non-limiting embodiments, the pressure checking step 4004 may include using a differential pressure sensor of the pressure sensing circuitry 3506 to measure the vacuum pressure generated by the vacuum pump 110. In some non-limiting embodiments, the checking step 4004 may include comparing the measured vacuum pressure generated by the vacuum pump 110 to a target sipper well evacuation pressure threshold (e.g., −27.5 in-Hg, −27 in-Hg, or −26.5 in-Hg). If the measured pressure is below the target sipper well evacuation pressure threshold, the first sipper well evacuation step 3902 may proceed to a step 4008, which may include closing the sipper valve. However, if an amount of time (e.g., 5 seconds) passes, and the measured pressure has not gone below the target sipper well evacuation pressure threshold, the priming station 100 may determine that the applied vacuum is insufficient for evacuating the sipper wells, and the alternative fluid degassing process 3900 may proceed to an error handling step 4006.

In some embodiments, the alternative fluid degassing process 3900 may include an error handling step 4006. In some embodiments, the error handling step 4006 may include turning the vacuum pump 110 off. In some embodiments, the error handling step 4006 may include informing the user that an error (e.g., an insufficient pressure error) has occurred (e.g., by using the membrane panel 118 to display an error indication). In some non-limiting embodiments, the error handling step 4006 may include opening all of the valves 422, waiting for an amount of time (e.g., 10 seconds), and then closing all of the valves 422.

As shown in FIG. 40, the vent and waste well evacuation step 3904 may include a step 4010 of applying a vacuum to the vent and waste wells of the cartridge 200. In some non-limiting embodiments, the step 4002 may include opening the vent valves (e.g., the bank of valves 422 for the vent wells of the cartridge 200) and opening the waste valves (i.e., the bank of valves 422 for the waste wells of the cartridge 200).

In some embodiments, the vent and waste well evacuation step 3904 may include a step 4012 of checking whether the applied vacuum is sufficient for evacuating the vent and waste wells. In some non-limiting embodiments, the pressure checking step 4012 may include using a differential pressure sensor of the pressure sensing circuitry 3506 to measure the vacuum pressure generated by the vacuum pump 110. In some non-limiting embodiments, the checking step 4012 may include comparing the measured vacuum pressure generated by the vacuum pump 110 to a target vent and waste well evacuation pressure threshold (e.g., −25.5 in-Hg, −25 in-Hg, or −24.5 in-Hg). If the measured pressure is below the target vent and waste well evacuation pressure threshold, the vent and waste well evacuation step 3904 may proceed to a step 4014, which may include closing the vent and waste valves. However, if an amount of time (e.g., 5 seconds) passes, and the measured pressure does not go below the target vent and waste well evacuation pressure threshold, the priming station 100 may determine that the applied vacuum is insufficient for evacuating the vent and waste wells, and the alternative fluid degassing process 3900 may proceed to the error handling step 4006.

As shown in FIG. 40, the second sipper well evacuation step 3906 may include a step 4016 of applying a vacuum to the sipper wells of the cartridge 200. In some non-limiting embodiments, the step 4016 may include pulling a vacuum over the common sipper fluid reservoir 706 to degas the fluid before priming. In some non-limiting embodiments, the step 4016 may include opening the sipper valve.

In some embodiments, the second sipper well evacuation step 3906 may include a step 4018 of checking whether the applied vacuum is sufficient for degassing the fluid. In some non-limiting embodiments, the pressure checking step 4018 may include using a differential pressure sensor of the pressure sensing circuitry 3506 to measure the vacuum pressure generated by the vacuum pump 110. In some non-limiting embodiments, the checking step 4018 may include comparing the measured vacuum pressure generated by the vacuum pump 110 to a target degassing pressure threshold (e.g., −27.5 in-Hg, −27 in-Hg, or −26.5 in-Hg). If the measured pressure is above the target degassing pressure threshold, the priming station 100 may determine that the applied vacuum is insufficient for degassing the fluid, and the alternative fluid degassing process 3900 may proceed to the error handling step 4006. However, if the measured pressure is not above the target degassing pressure threshold, the second sipper well evacuation step 3906 may proceed to a step 4020 to check whether the fluid degassing is complete.

In some embodiments, the second sipper well evacuation step 3906 may include a step 4020 of checking whether the fluid degassing is complete. In some non-limiting embodiments, checking whether the fluid degassing is complete may include checking whether a degas time (e.g., 3 min) has expired. However, this is not required, and, in some alternative embodiments, the step 4020 may determine whether degassing is complete in another manner (e.g., measuring dissolved gasses in the fluid using, for example and without limitation, an oxygen meter, and determining that degassing is complete when the measurement indicates that dissolved gasses are below a target level).

In some embodiments, if fluid degassing is determined to be not complete in step 4020, the second sipper well evacuation step 3906 may proceed back to the pressure checking step 4018. However, in some embodiments, if fluid degassing is determined to be complete in step 4020, the second sipper well evacuation step 3906 may proceed to a step 4022, in which the vacuum pump 110 may be turned off. In some embodiments, the step 4022 may include closing the sipper valve.

In some embodiments, the alternative fluid degassing process 3900 illustrated in FIGS. 39 and 40 may require less time to degas the priming fluid than the fluid degassing process 3800 illustrated in FIG. 38 (e.g., a reduction in time of approximately 50% such as, for example and without limitation, 3.5 minutes or less instead of 7.5 minutes). In some embodiments, shortening the degas duration time may reduce vacuum degradation caused by fluid condensation in the vacuum pump 110, which may occur while the vacuum pump 110 is in use.

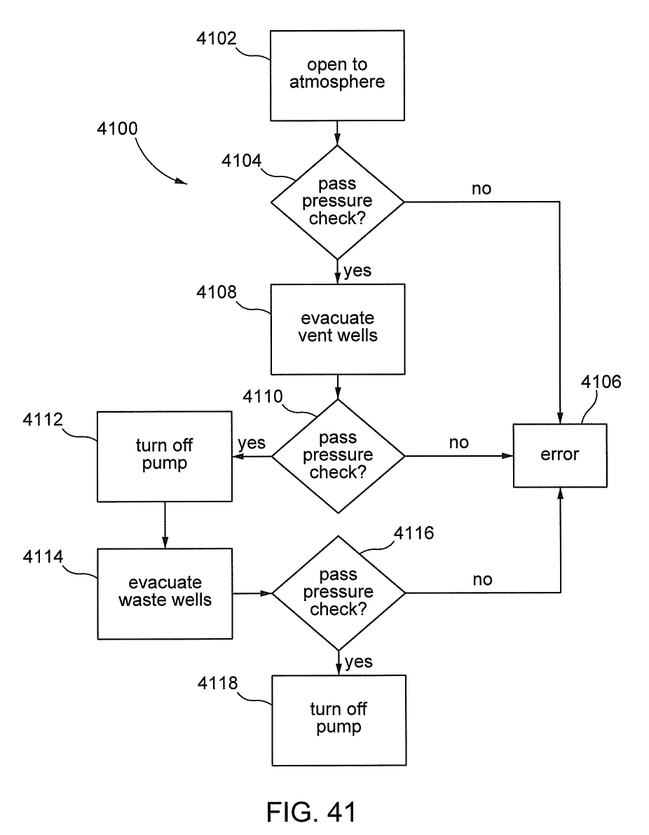

In some embodiments, after completion of the fluid degassing step 3606, the priming process 3600 may proceed to the cartridge evacuation step 3608. In some non-limiting embodiments, the cartridge evacuation step 3608 may include applying a vacuum (e.g., deep vacuum levels) over the vent wells of the cartridge 200 and then applying a vacuum (e.g., deep vacuum levels) over the waste wells of the cartridge 200. FIG. 41 is a flowchart illustrating a process 4100 that may be performed during the cartridge evacuation step 3608 of priming process 3600 according to one non-limiting embodiment.

As shown in FIG. 41, the cartridge evacuation process 4100 may include a step 4102 of opening the waste manifold 408 to atmosphere. In some non-limiting embodiments, the step 4102 may include opening the vent valves and opening the atmospheric valve (e.g., the valve 422 for the atmospheric channel 1404 of the waste manifold 408 (see FIG. 14)).

In some embodiments, the cartridge evacuation process 4100 may include a step 4104 of checking pressure. In some non-limiting embodiments, the pressure checking step 4104 may include using a differential pressure sensor of the pressure sensing circuitry 3506 to measure the vacuum pressure (if any). In some non-limiting embodiments, the checking step 4104 may include comparing the measured vacuum pressure to a target vent priming pressure threshold (e.g., −22.95 in-Hg, −22.7 in-Hg, or −22.45 in-Hg). If the measured pressure is above the target vent priming pressure threshold, the cartridge evacuation process 4100 may proceed to a step 4108 to evacuate the vent wells of the cartridge 200. However, if an amount of time (e.g., 5 seconds) passes, and the pressure has not gone above the target vent priming pressure threshold, the cartridge evacuation process 4100 may proceed to an error handling step 4106.

In some embodiments, the error handling step 4106 may include turning the vacuum pump 110 off (if the vacuum pump 110 is on). In some embodiments, the error handling step 4106 may include informing the user that an error (e.g., a pressure error) has occurred (e.g., by using the membrane panel 118 to display an error indication). In some non-limiting embodiments, the error handling step 4106 may include opening all of the valves 422, waiting for an amount of time (e.g., 10 seconds), and then closing all of the valves 422.

In some embodiments, the cartridge evacuation process 4100 may include a step 4108 of evacuating the vent wells of the cartridge 200. In some non-limiting embodiments, the vent well evacuation step 4108 may include closing the atmospheric valve and turning on the vacuum pump 110. In non-limiting alternative embodiments, instead of automatically turning on the vacuum pump 110, the vent well evacuation step 4108 may include measuring the vacuum pressure (e.g., using a differential pressure sensor of the pressure sensing circuitry 3506) and turning on the vacuum pump 110 only if the measured vacuum pressure is greater than the measured vacuum pressure to a target vent priming pressure threshold (e.g., −22.95 in-Hg, −22.7 in-Hg or −22.45 in-Hg).

In some embodiments, the cartridge evacuation process 4100 may include a step 4110 of checking pressure. In some non-limiting embodiments, the pressure checking step 4110 may include using a differential pressure sensor of the pressure sensing circuitry 3506 to measure the vacuum pressure. In some non-limiting embodiments, the checking step 4110 may include determining whether the measured vacuum pressure is within a target vent priming pressure tolerance (e.g., −22.7 in-Hg±0.25 in-Hg). If the measured pressure is within the target vent priming pressure tolerance, the cartridge evacuation process 4100 may proceed to a step 4112 to turn off the vacuum pump 110 in case the vacuum pump 110 was turned on during the vent well evacuation step 4108. However, if an amount of time (e.g., 10 seconds) passes, and the pressure has not gone within the target vent priming pressure tolerance, the cartridge evacuation process 4100 may proceed to the error handling step 4106.

In some embodiments, the cartridge evacuation process 4100 may include a step 4114 of evacuating the waste wells of the cartridge 200. In some non-limiting embodiments, the waste well evacuation step 4114 may include closing the vent valves, opening the waste valves, and turning on the vacuum pump 110.

In some embodiments, the cartridge evacuation process 4100 may include a step 4116 of checking pressure. In some non-limiting embodiments, the pressure checking step 4110 may include using a differential pressure sensor of the pressure sensing circuitry 3506 to measure the vacuum pressure generated by the vacuum pump 110. In some non-limiting embodiments, the checking step 4116 may include determining whether the measured vacuum pressure is within a target waste priming pressure tolerance (e.g., −28 in-Hg±0.25 in-Hg). If the measured pressure is within the target vent priming pressure tolerance, the cartridge evacuation process 4100 may proceed to a step 4118 to turn off the vacuum pump 110. However, if an amount of time (e.g., 10 seconds) passes, and the pressure has not gone within the target waste priming pressure tolerance, the cartridge evacuation process 4100 may proceed to the error handling step 4106.

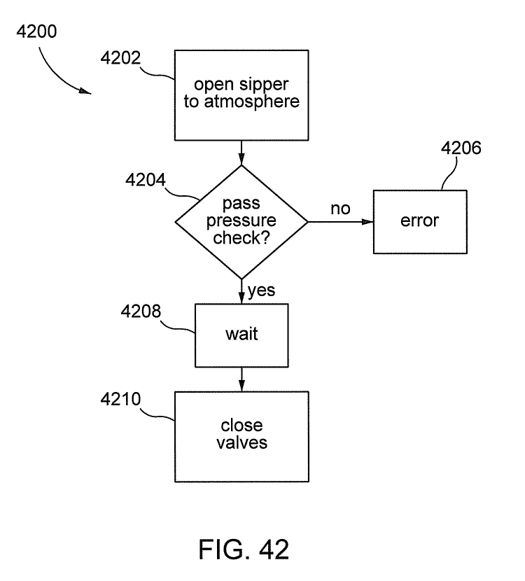

In some embodiments, after completion of the cartridge evacuation step 3608, the priming process 3600 may proceed to the cartridge priming step 3610. In some non-limiting embodiments, the cartridge priming step 3610 may include applying a minimal vacuum level may be set over the sipper wells to push fluid through the cartridge 200. FIG. 42 is a flowchart illustrating a process 4200 that may be performed during the cartridge priming step 3610 of the priming process 3600 according to one non-limiting embodiment.

As shown in FIG. 42, the cartridge priming process 4200 may include a step 4202 of opening the common sipper fluid reservoir 706 to atmosphere. In some non-limiting embodiments, the step 4202 may include closing the waste valves, opening the sipper valve, and opening the atmospheric valve.

In some embodiments, the cartridge priming process 4200 may include a step 4204 of checking pressure. In some non-limiting embodiments, the pressure checking step 4204 may include using a differential pressure sensor of the pressure sensing circuitry 3506 to measure the vacuum pressure. In some non-limiting embodiments, the checking step 4204 may include determining whether the measured vacuum pressure is within a target sipper priming pressure tolerance (e.g., −5.2 in-Hg±1.5 in-Hg). If the measured pressure is within the target sipper priming pressure tolerance, the cartridge priming process 4200 may proceed to a step 4208 to allow fluid from the common sipper fluid reservoir 706 to be drawn into the cartridge 200. However, if an amount of time (e.g., 15 seconds) passes, and the pressure has not gone within the target sipper priming pressure threshold, the cartridge priming process 4200 may proceed to an error handling step 4206.

In some embodiments, the error handling step 4206 may include turning the vacuum pump 110 off. In some embodiments, the error handling step 4206 may include informing the user that an error (e.g., a pressure error) has occurred (e.g., by using the membrane panel 118 to display an error indication). In some non-limiting embodiments, the error handling step 4206 may include opening all of the valves 422, waiting for an amount of time (e.g., 10 seconds), and then closing all of the valves 422.

In some embodiments, the cartridge priming process 4200 may include a step 4208 of allowing fluid from the common sipper fluid reservoir 706 to be drawn into the cartridge 200. In some non-limiting embodiments, the step 4208 may include waiting for an amount of time (e.g., 30 seconds). However, this is not required, and, in some alternative embodiments, the step 4208 may include, for example, detecting that a sufficient amount of fluid has been drawn into the cartridge 200 instead of waiting for an amount of time.

In some embodiments, the cartridge priming process 4200 may include a step 4210 of closing the sipper and atmospheric valves.

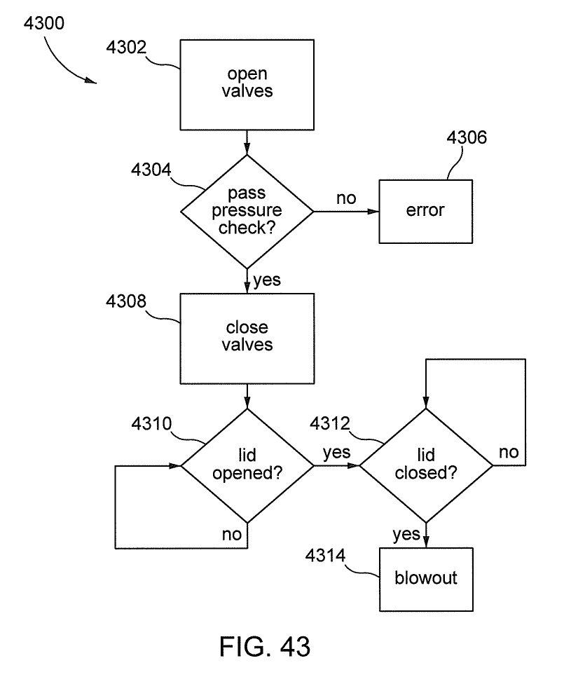

In some embodiments, after completion of the cartridge priming step 3610, the priming process 3600 may proceed to the cartridge removal step 3612. In some non-limiting embodiments, the cartridge removal step 3612 may include releasing the vacuums over the cartridge and waiting for lid of the priming station 100 to be opened. FIG. 43 is a flowchart illustrating a process 4300 that may be performed during the cartridge removal step 3612 of the priming process 3600 according to one non-limiting embodiment.

As shown in FIG. 43, the cartridge removal process 4300 may include a step 4302 of opening all valves 422 and then waiting for an amount of time (e.g., 10 seconds).

In some embodiments, the cartridge removal process 4300 may include a step 4304 of checking pressure. In some non-limiting embodiments, the pressure checking step 4304 may include using a differential pressure sensor of the pressure sensing circuitry 3506 to measure the vacuum pressure. In some non-limiting embodiments, the checking step 4204 may include determining whether the measured vacuum pressure is within a target chip removal pressure tolerance (e.g., 0 in-Hg±1.5 in-Hg). If the measured pressure is within the target chip removal pressure tolerance, the cartridge removal process 4300 may proceed to a step 4308. However, if an amount of time (e.g., 10 seconds) passes, and the pressure has not gone within the target cartridge removal pressure threshold, the cartridge removal process 4300 may proceed to an error handling step 4306.

In some embodiments, the error handling step 4306 may include informing the user that an error (e.g., a pressure error) has occurred (e.g., by using the membrane panel 118 to display an error indication). In some non-limiting embodiments, the error handling step 4306 may include opening all of the valves 422, waiting for an amount of time (e.g., 10 seconds), and then closing all of the valves 422.

In some embodiments, the cartridge removal process 4300 may include a step 4308 of closing all of the valves 422.

In some embodiments, the cartridge removal process 4300 may include a step 4310 of checking whether the lid of the priming station 100 has been opened. In some embodiments, opening of the lid of the priming station 100 may actuate the door closure indicator 3502 (e.g., a limit switch) to indicate that the lid is open, which may be detected by the controller 3504. If a lid opening is detected, the cartridge removal process 4300 may proceed to a step 4312 of detecting whether the lid of the priming station 100 has been closed.

In some embodiments, the cartridge removal process 4300 may include a step 4312 of checking whether the lid of the priming station 100 has been closed. In some embodiments, closing and latching of the lid of the priming station 100 may actuate the door closure indicator 3502 (e.g., a limit switch) to indicate lid closure, which may be detected by the controller 3504. If lid closure is detected, the cartridge removal process 4300 may proceed to a step 4314 of initiating removal of condensed fluid from the vacuum pump 110.

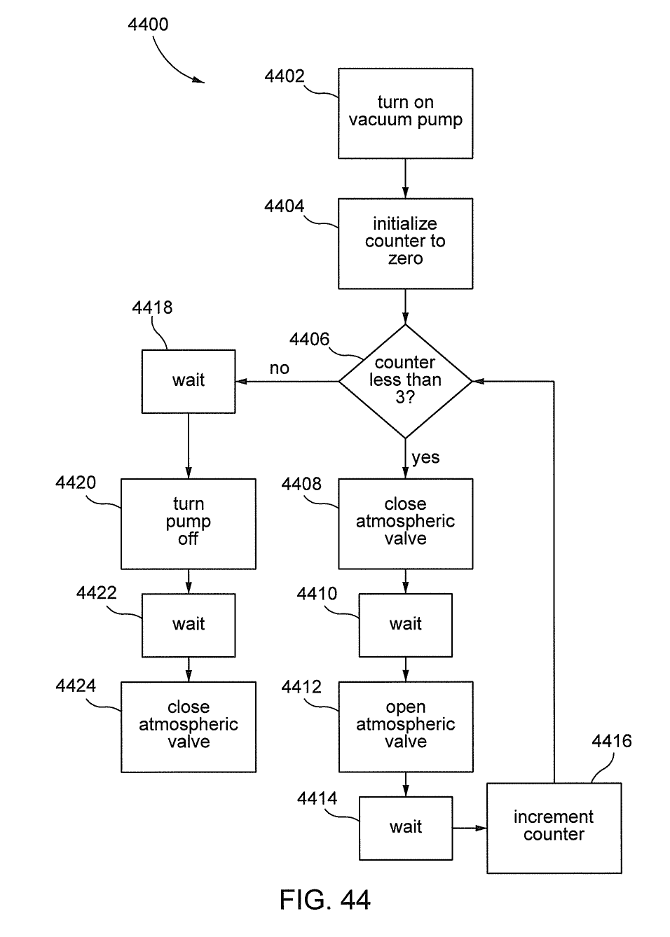

In some non-limiting embodiments, the step 4314 may include running a blowout routine to dry out the vacuum lines and vacuum pump 110. FIG. 44 is a flowchart illustrating a process 4400 that may be performed during the vacuum pump blowout step 4314 of the cartridge removal process 4300 according to one non-limiting embodiment.

As shown in FIG. 44, the vacuum pump blowout process 4400 may include a step 4402 of waiting for an amount of time (e.g., 4 seconds) after the detection of the lid closure step 4312 of the cartridge removal process 4300 and then turning on the vacuum pump 110. In some embodiments, the vacuum pump blowout process 4400 may include a step 4404 of initializing a counter to zero.

In some embodiments, the vacuum pump blowout process 4400 may include a step 4406 of determining whether the counter is less than a number (e.g., 3). In some embodiments, if the counter is less than the number, the vacuum pump blowout process 4400 may proceed to a step 4408. However, in some embodiments, if the counter is greater than or equal to the number, the vacuum pump blowout process 4400 may proceed to a step 4418.

In some embodiments, the vacuum pump blowout process 4400 may include a step 4408 of closing the atmospheric valve, which may be performed if the counter is determined to be less than the number in step 4406. In some embodiments, the vacuum pump blowout process 4400 may include a step 4410 of waiting an amount of time (e.g., 5 seconds). In some embodiments, the vacuum pump blowout process 4400 may include a step 4412 of opening the atmospheric valve. In some embodiments, the vacuum pump blowout process 4400 may include a step 4414 of waiting an amount of time (e.g., 5 seconds). In some embodiments, the vacuum pump blowout process 4400 may include a step 4416 of incrementing the counter.

In some embodiments, the vacuum pump blowout process 4400 may include a step 4418 of waiting (e.g., 90 seconds), which may be performed if the counter is determined to be greater than or equal to the number in step 4406. In some embodiments, the vacuum pump blowout process 4400 may include a step 4420 of turning off the vacuum pump 110. In some embodiments, the vacuum pump blowout process 4400 may include a step 4422 of waiting (e.g., 4 seconds). In some embodiments, the vacuum pump blowout process 4400 may include a step 4424 of closing the atmospheric valve.

In some embodiments, the cartridge evacuation step 3608 of the priming process 3600 may evacuate the cartridge 200 thoroughly prior to introducing priming fluid (e.g., DI water) into the cartridge 200 in the cartridge priming step 3610. In some embodiments, the cartridge evacuation step 3608 may prevent or reduce the formation of bubbles in the fluidic channels of the cartridge 200, which may lead to lost channels and/or failed cartridge runs, by evacuating air from the cartridge 200.

Preventing or Reducing Bubbles in the Fluidic Channels

Bubbles in the one or more fluidic channels of the cartridge 200 may be caused by an air and fluid mixture in the U-K connection hole (i.e., the connection between the K-chip 212 and the U-chip 214) and/or air in a channel prior to introducing the priming fluid. The air and fluid mixture in the U-K connection hole may be caused by unintentional cartridge priming, which may occur (i) when the lid of the priming station 100 is closed, (ii) during fluid loading step 3604 following the cartridge loading step 3602, and/or (iii) during a blowout routine to remove fluid from the vacuum pump 110. In some embodiments, the cartridge evacuation step 3608 may remove the air and fluid mixture thoroughly prior to introducing priming fluid and, thus, may prevent and/or reduce the bubble formation that would otherwise occur as a result of unintentional cartridge priming. However, in some non-limiting embodiments, the priming station 100 may take one or more measures to avoid unintentional cartridge priming.

For example, in some non-limiting embodiments, the lid closure detection step 3702 of the cartridge loading process 3700 (see FIG. 37) may include opening the atmospheric valve while waiting for detection of a lid closure to reduce and/or prevent increased pressure caused by closing the lid, which may push fluid into the cartridge 200 from the common sipper fluid reservoir 706.

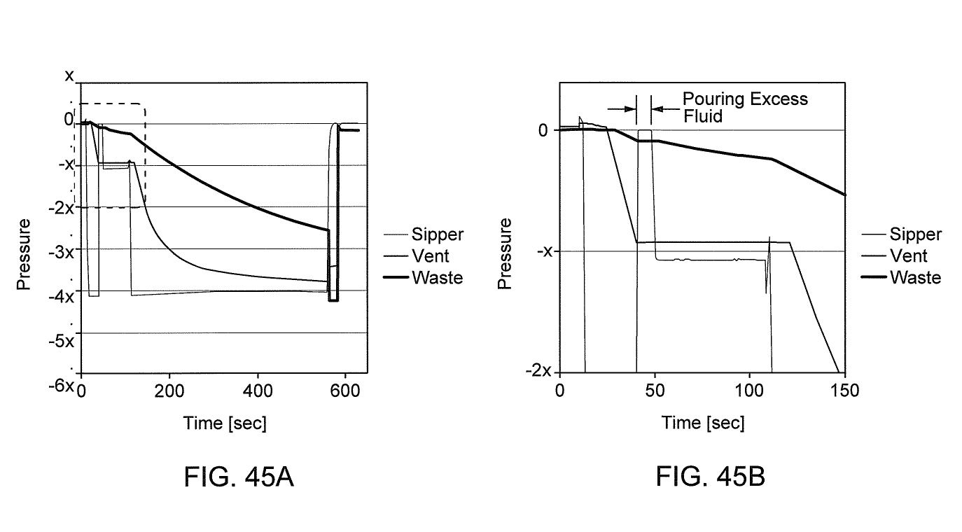

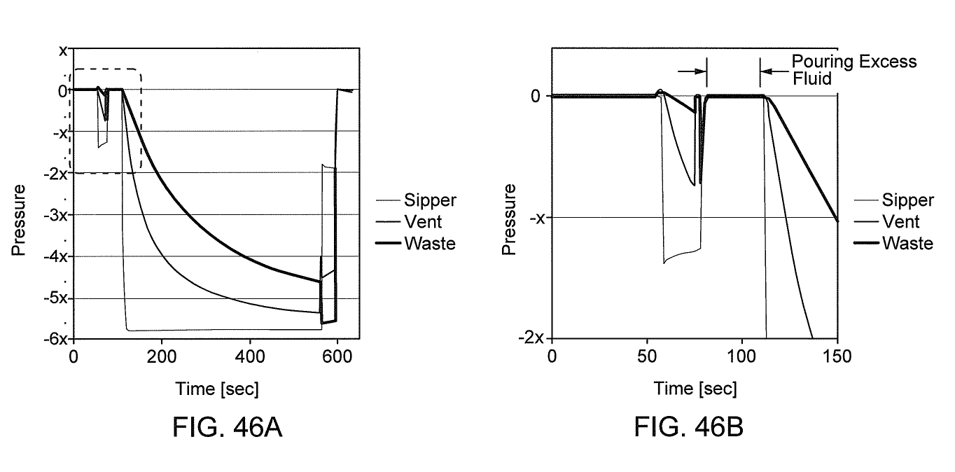

Similarly, in some non-limiting embodiments, the fluid loading step 3604 of the priming process 3600 (see FIG. 36) may include opening the atmospheric valve and ensuring that the pressure at the vent and waste wells of the cartridge 200 is greater than the pressure at the sipper wells, which may prevent the fluid from being pulled into the cartridge 200 from the common sipper fluid reservoir 706 during the degassing step (e.g., degassing step 3606 of the priming process 3600 illustrated in FIG. 36). This is illustrated by the pressure profile examples of FIGS. 45A-46B, which are described below.

FIG. 45A shows a pressure profile of the priming process according to one non-limiting embodiment, and FIG. 45B shows a magnified portion of the pressure profile, which is identified by the dashed rectangle of FIG. 45A. As shown in FIGS. 45A and 45B, at about 50 seconds, there is a step of pouring excess fluid into the common sipper fluid reservoir 706. In some non-limiting embodiments, the step of pouring excess fluid into the common sipper fluid reservoir 706 may correspond to the fluid loading step 3604 of the priming process 3600 illustrated in FIG. 36. In the pressure profile shown in FIGS. 45A and 45B, the vent and waste well pressures are less than with sipper well pressure, and this pressure difference pulls priming fluid into a fluidic channel of the cartridge 200 (i.e., the pressure difference primes the cartridge 200 unintentionally).

FIG. 46A shows a pressure profile of the priming process according to a non-limiting alternative embodiment, and FIG. 46B shows a magnified portion of the alternative pressure profile, which is identified by the dashed rectangle in FIG. 46A. As shown in FIGS. 46A and 46B, the alternative pressure profile does not have the pressure difference shown in FIGS. 45A and 45B. That is, in the pressure profile shown in FIGS. 46A and 46B, the vent and waste well pressures are not less than the sipper well pressure. As shown in FIG. 46B, the vent and waste well pressure come to the atmospheric pressure before the sipper well pressure comes to the atmospheric pressure. As the vent and waste well pressures are not less than the sipper well pressure, fluid from the common sipper fluid reservoir 706 is not pulled into the fluidic channels of the cartridge 200.

Blowout Routine

In some non-limiting embodiments, the priming process 3600 may only include a blowout routine at the end of the priming procedure (e.g., after the primed cartridge has been removed from the priming station 100). The blowout routine is intended to eliminate condensed fluid from a vacuum pump 110. The vacuum pump blowout process 4400 shown in FIG. 44 is a non-limiting example of blowout routine that may occur during the blowout step 4314 of the cartridge removal process 4300 shown in FIG. 43 that may occur during the cartridge removal step 3612 of the priming process 3600 shown in FIG. 36.

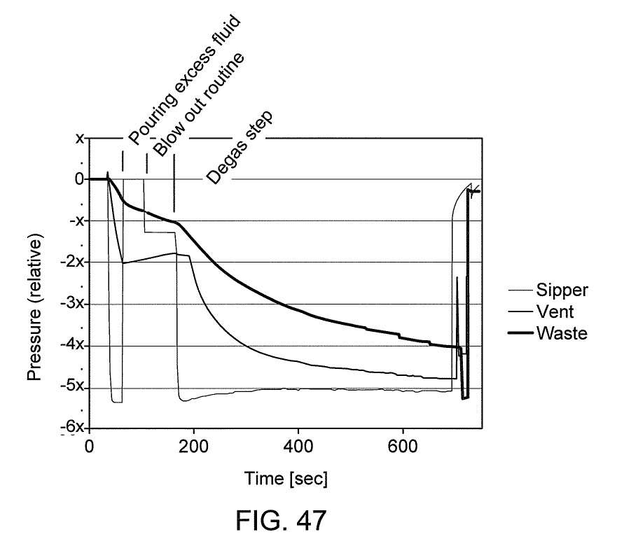

FIG. 47 illustrates a pressure profile of a priming process according to a non-limiting embodiment that includes two blowout steps (e.g., one blowout routine at the beginning of the priming process and one at the end). FIG. 47 illustrates a first blowout routine that occurs following the pouring excess fluid step and prior to the degas step. In some embodiments, the blowout routine is intended to pass air into and through the vacuum pump 110 through a bypass route. The blowout routine may cause unintended negative pressure in the pressure lines, which may crack open normally closed valves. Thus, a blowout routine that is performed at the start of the priming process while the cartridge is loaded may pull fluid into the cartridge 200 prior to the intended start of the priming process.

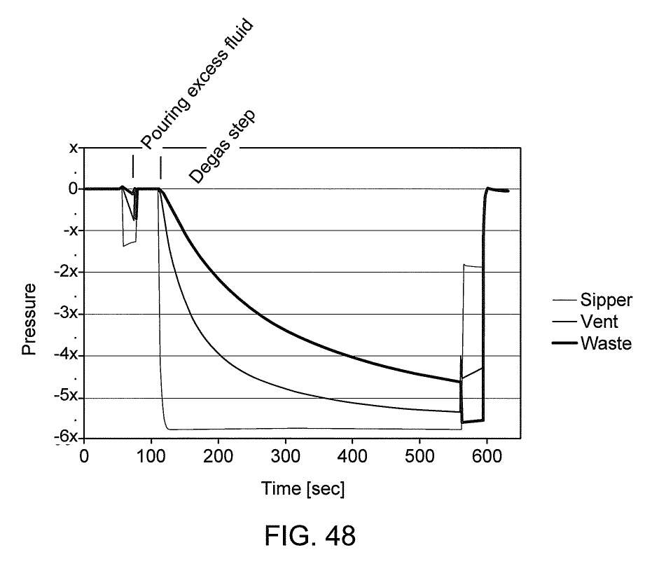

Some non-limiting embodiments may avoid this issue by combining the first and second blowout routines into a single blowout routine (e.g., the vacuum pump blowout process 4400 shown in FIG. 44) that is performed by the priming station 100 after removal of the primed cartridge from the priming station 100. FIG. 48 illustrates a pressure profile of a priming process according to a non-limiting alternative embodiment in which a blowout routine is not performed until after the cartridge 200 is removed from the priming station 100. As shown in FIG. 48, instead of performing a blowout routine following the fluid loading/pouring step, the priming process goes directly into a degas step following the fluid loading/pouring step.

Shortening the Degassing Step

Condensation in the vacuum pump 110 may degrade the performance of the vacuum pump 110. Even in embodiments of the priming station 100 that include the hydrophobic filter 108, which is intended to prevent fluid from reaching the vacuum pump 110, in some embodiments, some fluid (e.g., in the form of water vapor) may go through the hydrophobic filter 108 and get into the vacuum pump 110. Water vapor that reaches the vacuum pump 110 may condense inside the vacuum pump 110. The condensed fluid may stick on a portion of the one way valve of the vacuum pump 110, which may lead to a reduced vacuum level.

Countermeasures to fluid in the vacuum pump include one of more of (i) the blowout routine (see, e.g., the vacuum pump blowout process 4400 illustrated in FIG. 44), (ii) using a plastic vacuum pump for the vacuum pump 110, and (iii) shortening the degassing step (e.g., degassing step 3606 of the priming process 3600 illustrated in FIG. 36).

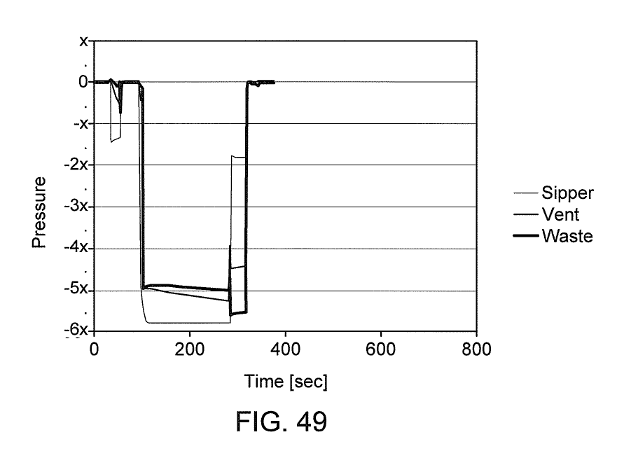

In some embodiments, the degassing step 3606 may include evacuating the ports of the cartridge 200 in a specific order to avoid pulling fluid from the common sipper fluid reservoir 706 into the channels of the cartridge 200, which may occur with any pressure difference prior to the priming step (e.g., cartridge priming step 3610 of the priming process 3600). In particular, in some non-limiting embodiments, as shown in the alternative fluid degassing process 3900 illustrated in FIGS. 39 and 40, the specific order may be (i) evacuating the sipper wells, (ii) evacuating the vent and waste wells, and (iii) evacuating the sipper wells a second time. In some embodiments, high vacuums (e.g., less than −24.5 in-Hg) may be used during fluid degassing, which may shorten the degassing time. FIG. 49 illustrates a pressure profile of the priming process according to a non-limiting embodiment. In some non-limiting embodiments, the pressure profile illustrated in FIG. 49 may shorten the duration of the process by one or more of (i) evacuating with high vacuum from a sipper reservoir first, (ii) then evacuating vents and wastes respectively before sipper pressure decay, and (iii) then evacuating from a sipper again.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, although embodiments of the priming station 100 having a PCB 106 have been described, the priming station 100 does not require a PCB 106, and, in some alternative embodiments, the priming station 100 may additionally or alternatively have an application specific integrated circuit (ASIC) that performs the functions of one or more of the components (e.g., the controller 3504) of the PCB 108. For another example, although embodiments in which the priming station 100 uses water as the priming fluid are described above, the priming fluid is not limited to water, and, in some alternative embodiments, a different fluid may be used as the priming fluid.

What is claimed is:

1. A method of preparing a fluidic cartridge for use in an analyzer device, the method comprising:
controlling valves and a vacuum pump of a priming station to evacuate air from a fluidic cartridge loaded in the priming station; and
controlling the valves and the vacuum pump to draw priming fluid into sipper wells and channels of the loaded fluidic cartridge.

2. The method of claim 1, wherein controlling the valves and the vacuum pump of the priming station to evacuate the air from the loaded fluidic cartridge comprises controlling the valves and the vacuum pump to open waste and vent wells of the loaded fluidic cartridge to atmosphere.

3. The method of claim 2, wherein controlling the valves and the vacuum pump of the priming station to evacuate the air from the loaded fluidic cartridge further comprises:
controlling the valves and the vacuum pump to evacuate air from the vent wells; and
controlling the valves and the vacuum pump to evacuate air from the waste wells.

4. The method of claim 1, wherein controlling the valves and the vacuum pump to draw priming fluid into the sipper wells and the channels of the loaded fluidic cartridge comprises controlling the valves and the vacuum pump to open the sipper wells to atmosphere.

5. The method of claim 1, further comprising controlling the valves and the vacuum pump to perform a blowout routine after removal of the loaded fluidic cartridge.

6. The method of claim 1, further comprising controlling the valves and the vacuum pump to degas priming fluid in a sipper fluid reservoir of the priming station.

7. The method of claim 6, wherein controlling the valves and the vacuum pump to degas priming fluid in the sipper fluid reservoir of the priming station comprises:
evacuating sipper wells of the loaded fluidic cartridge;
after evacuating sipper wells of the loaded fluidic cartridge, evacuating vent and waste wells of the loaded fluidic cartridge; and
after evacuating vent and waste wells of the loaded fluidic cartridge, evacuating sipper wells of the loaded fluidic cartridge.

8. The method of claim 1, further comprising controlling the valves and the vacuum pump such that the pressure in vent wells of the loaded fluidic cartridge and the pressure in the waste wells of the loaded fluidic cartridge are each greater than the pressure in the sipper wells while waiting for priming fluid to be loaded into the priming station.

9. The method of claim 1, wherein the priming fluid is water.

10. The method of claim 1, wherein the priming fluid is deionized water.

11. A priming station for preparing a fluidic cartridge for use in an analyzer device, the priming station comprising:
a vacuum pump;
a priming manifold assembly configured to interface with a fluidic cartridge loaded in the priming station, wherein the priming manifold assembly comprises:
valves;
a vent-sipper manifold including a sipper fluid reservoir configured to store priming fluid, wherein the vent-sipper manifold is configured to connect a vacuum line from the vacuum pump to the sipper fluid reservoir via one of the valves and to connect a vacuum line from the vacuum pump to vent wells of the loaded fluidic cartridge via one or more of the valves; and
a vent-sipper gasket configured to create a seal between the vent-sipper manifold and a surface of the loaded fluidic cartridge, wherein priming fluid is capable of being drawn from the sipper fluid reservoir into sipper wells of the loaded fluidic cartridge; and
a controller configured to control the vacuum pump and the valves to draw priming fluid from the sipper fluid reservoir into sipper wells and channels of the loaded fluidic cartridge.

12. The priming station of claim 11, wherein the priming manifold assembly further comprises a waste manifold configured to connect a vacuum line from the vacuum pump to waste wells of the loaded fluidic cartridge via one or more of the valves.

13. The priming station of claim 12, wherein the priming manifold assembly further comprises a waste well gasket configured to create a seal between the waste manifold 408 and a surface of the loaded fluidic cartridge.

14. The priming station of claim 12, wherein the waste manifold is configured to connect waste wells of the loaded fluidic cartridge to atmosphere via one the valves.

15. The priming station of claim 11, wherein the vent-sipper manifold further includes a cartridge detect channel configured to be blocked by the loaded fluidic cartridge and configured to open to atmosphere if no fluidic cartridge is present.

16. The priming station of claim 11, wherein the controller is further configured to control the vacuum pump and the valves to degas priming fluid in the sipper fluid reservoir.

17. The priming station of claim 11, wherein the controller is further configured to control the vacuum pump and the valves to evacuate the loaded fluidic device before controlling the vacuum pump and the valves to draw priming fluid from the sipper fluid reservoir into sipper wells and channels of the loaded fluidic cartridge.

18. The priming station of claim 11, wherein the priming fluid is water.

19. The priming station of claim 11, wherein the priming fluid is deionized water.

20. The priming station of claim 11, wherein the vent-sipper manifold further includes a fluid fill channel configured to allow priming fluid to enter the sipper fluid reservoir.

21. The priming station of claim 11, wherein the vent-sipper gasket is configured to create a common sipper volume with the sipper fluid reservoir.

22. A priming station for preparing a fluidic cartridge for use in an analyzer device, the priming station comprising:
a base plate configured to support the fluidic cartridge;
one or more manifolds;
a manifold frame configured to support the one or more manifolds;
a manifold gasket configured to create a seal between the manifold frame and the base plate;
one or more manifold gaskets configured to create a seal between the manifold frame and the one or more manifolds; and
one or more gaskets configured to create a seal between the one or more manifolds and a surface of the fluidic cartridge.

23. The priming station of claim 22, wherein the one or more manifolds comprise a vent-sipper manifold.

24. The priming station of claim 23, wherein the one or more gaskets configured to create the seal between the one or more manifolds and the surface of the fluidic cartridge comprises a vent-sipper gasket configured to create a seal between the vent-sipper manifold and the surface of the loaded fluidic cartridge.

25. The priming station of claim 23, wherein the one or more manifold gaskets configured to create the seal between the manifold frame and the one or more manifolds comprises a vent-sip manifold gasket configured to create a seal between the manifold frame and the vent-sipper manifold.

26. The priming station of claim 25, wherein the manifold frame comprises a gasket ridge configured to abut at least a portion of an interior surface of the vent-sip manifold gasket.

27. The priming station of claim 22, wherein the one or more manifolds comprise a waste manifold.

28. The priming station of claim 27, wherein the one or more gaskets configured to create the seal between the one or more manifolds and the surface of the fluidic cartridge comprises a waste gasket configured to create a seal between the waste manifold and the surface of the loaded fluidic cartridge.

29. The priming station of claim 27, wherein the one or more manifold gaskets configured to create the seal between the manifold frame and the one or more manifolds comprises a waste manifold gasket configured to create a seal between the manifold frame and the waste manifold.

30. The priming station of claim 29, wherein the manifold frame comprises a gasket ridge configured to abut at least a portion of an interior surface of the waste manifold gasket.

31. The priming station of claim 22, wherein the manifold frame comprises a gasket ridge configured to abut at least a portion of an interior surface of the manifold gasket configured to create the seal between the manifold frame and the base plate.
